(19) United States
(12) Patent Application Publication
(10) Pub. No.: US 2017/0053555 A1
(43) Pub. Date: Feb. 23, 2017

(54) SYSTEM AND METHOD FOR EVALUATING DRIVER BEHAVIOR

(71) Applicant: Trimble Navigation Limited, Sunnyvale, CA (US)

(72) Inventors: James W. Angel, Mansfield, TX (US); Michael D. Nalepka, Franklin, TN (US)

(21) Appl. No.: 14/930,338

(22) Filed: Nov. 2, 2015

Related U.S. Application Data
(63) Continuation of application No. 14/832,843, filed on Aug. 21, 2015, now abandoned.

(51) Int. Cl. G09B 19/16; G09B 5/00; G07C 5/00

(52) U.S. Cl. CPC G09B 19/167; G07C 5/008; G09B 5/00

(57) ABSTRACT

Systems and methods provide for receiving, at a central office, data and a video clip associated with a predetermined vehicle event produced by a plurality of commercial vehicles each operated by a driver. Driver behavior scoring is generated at the central office based on the received data and on manual evaluation of the video clip, wherein the driver behavior scoring is consistent with driver behavior scoring conducted by a governmental inspection authority. Driver violation data, collected from and scored by the governmental inspection authority, is acquired at the central office. An output is produced comprising at least the driver behavior scoring and the driver violation scoring for each of the drivers of the plurality of commercial vehicles.

### RELATED PATENT DOCUMENTS

This application is a continuation of U.S. Ser. No. 14/832,843, filed Aug. 21, 2015, which is incorporated herein by reference in its entirety.

### TECHNICAL FIELD

This application relates generally to systems and methods pertaining to detection of various data at a vehicle, and determining driver behavior based on the data acquired from the vehicle.

### SUMMARY

Various embodiments are directed to a method comprising receiving, at a central office, data and a video clip associated with a predetermined vehicle event produced by a plurality of commercial vehicles each operated by a driver. The method also comprises generating, at the central office, driver behavior scoring based the received data and on manual evaluation of the video clip, wherein the driver behavior scoring is consistent with driver behavior scoring conducted by a governmental inspection authority. The method further comprises acquiring, at the central office, driver violation data collected and scored by the governmental inspection authority, and producing an output comprising at least the driver behavior scoring and the driver violation scoring for each of the drivers of the plurality of commercial vehicles.

Some embodiments are directed to a method comprising receiving, at a central office, data associated with a predetermined vehicle event produced by a plurality of commercial vehicles each operated by a driver. The method also comprises generating, at the central office, driver behavior scoring based the received data, wherein the driver behavior scoring is consistent with driver behavior scoring conducted by a governmental inspection authority. The method further comprises acquiring, at the central office, driver violation data collected and scored by the governmental inspection authority, and producing an output comprising at least the driver behavior scoring and the driver violation scoring for each of the drivers of the plurality of commercial vehicles.

Other embodiments are directed to a system for use with commercial vehicles comprising a server configured to receive data and a video clip associated with a predetermined vehicle event produced by a plurality of commercial vehicles each operated by a driver. The server is also configured to receive driver violation data collected and scored by a governmental inspection authority. One or more scoring templates are provided for associating driver violations with severity ratings consistent with severity ratings established by the governmental inspection authority. One or more scoring modules are configured to algorithmically generate driver behavior scoring using the received data and the one or more scoring templates. A manual evaluation station is configured to facilitate manually generated driver behavior scoring using the video clip and the one or more scoring templates. A processor is configured to produce an output comprising at least the driver behavior scoring and the driver violation scoring for each of the drivers of the plurality of commercial vehicles.

Further embodiments are directed to a system for use with commercial vehicles comprising a server configured to receive data associated with a predetermined vehicle event produced by a plurality of commercial vehicles each operated by a driver. The server is also configured to receive driver violation data collected and scored by a governmental inspection authority. One or more scoring templates are provided for associating driver violations with severity ratings consistent with severity ratings established by the governmental inspection authority. one or more scoring modules are configured to algorithmically generate driver behavior scoring using the received data and the one or more scoring templates. A processor is configured to produce an output comprising at least the driver behavior scoring and the driver violation scoring for each of the drivers of the plurality of commercial vehicles.

The above summary is not intended to describe each disclosed embodiment or every implementation of the present disclosure. The figures and the detailed description below more particularly exemplify illustrative embodiments.

### BRIEF DESCRIPTION OF THE DRAWINGS

FIG. 1 illustrates a system for implementing video intelligence capture in accordance with various embodiments;

FIG. 2 is a block diagram of a system for communicating event data and video data for the vehicle using separate transceivers in accordance with various embodiments;

FIG. 3 is a block diagram of a system configured to implement video intelligence capture and evaluation in accordance with various embodiments;

FIG. 4A shows a series of video clips each associated with a different vehicle event in accordance with various embodiments;

FIG. 4B shows event data associated with the selected video clip shown in FIG. 4A in accordance with various embodiments;

FIG. 4C shows a map of the location where the vehicle event occurred for the video clip shown in FIG. 4A in accordance with various embodiments;

FIG. 5 is a block diagram of a system for scoring driver behavior in accordance with various embodiments;

FIG. 6 is a block diagram of a system for scoring driver behavior in accordance with other embodiments;

FIG. 7 is a block diagram of a system for scoring driver behavior in accordance with various embodiments;

FIG. 8 illustrates a method of manually evaluating video clips received from an onboard computer or mobile gateway provided at a multiplicity of commercial vehicles in accordance with various embodiments;

FIG. 9 shows a government inspection authority (GIA) scoring template that lists a number of event-based driver behaviors and associated severity ratings in accordance with various embodiments;

FIG. 10 shows a GIA scoring template that lists a number of driver behaviors (and associated severity ratings) that can be observed from video data acquired by a forward-looking camera in accordance with various embodiments;

FIG. 11 shows a GIA scoring template that lists a number of driver behaviors (and associated severity ratings) that can be observed from video data acquired by a driver-looking camera in accordance with various embodiments;

FIG. 12 shows a GIA scoring template that lists a number of event-based driver behaviors and associated severity ratings in accordance with various embodiments;

FIG. 13 is a representative screen or report generated from data stored in a driver behavior scoring database in accordance with various embodiments;

FIG. 14 illustrates various processes involving an in-cab review methodology in accordance with various embodiments;

FIGS. 15 and 16 show an in-cab device that can be used by a driver to conduct an in-cab review of an event packet received from the central office in accordance with various embodiments;

FIGS. 17 and 18 show different driver communication devices that can be used to facilitate review of event packets in accordance with various embodiments;

FIG. 19 illustrates various processes involving coaching of a driver using event packet review in accordance with various embodiments;

FIG. 20A illustrates an event review screen that can be made available to a safety manager and a driver on their respective devices to facilitate a coaching session in accordance with various embodiments;

FIG. 20B illustrates an event review screen that can be made available to an evaluator to facilitate review and scoring of a vehicle event in accordance with various embodiments;

FIG. 20C illustrates an event review screen that can be made available to a supervisor or a coach to facilitate driver coaching in accordance with various embodiments;

FIG. 20D illustrates an event review screen that can be made available to a user upon completion of event packet processing in accordance with various embodiments;

FIG. 21 is a block diagram of an apparatus for acquiring and processing video, audio, event, sensor, and other data for a commercial vehicle in accordance with various embodiments;

FIG. 22 is a block diagram of an apparatus for acquiring and processing video, audio, event, sensor, and other data for a commercial vehicle in accordance with various embodiments; and

FIG. 23 is a block diagram of an apparatus for acquiring and processing video, audio, event, sensor, and other data for a commercial vehicle in accordance with various embodiments.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

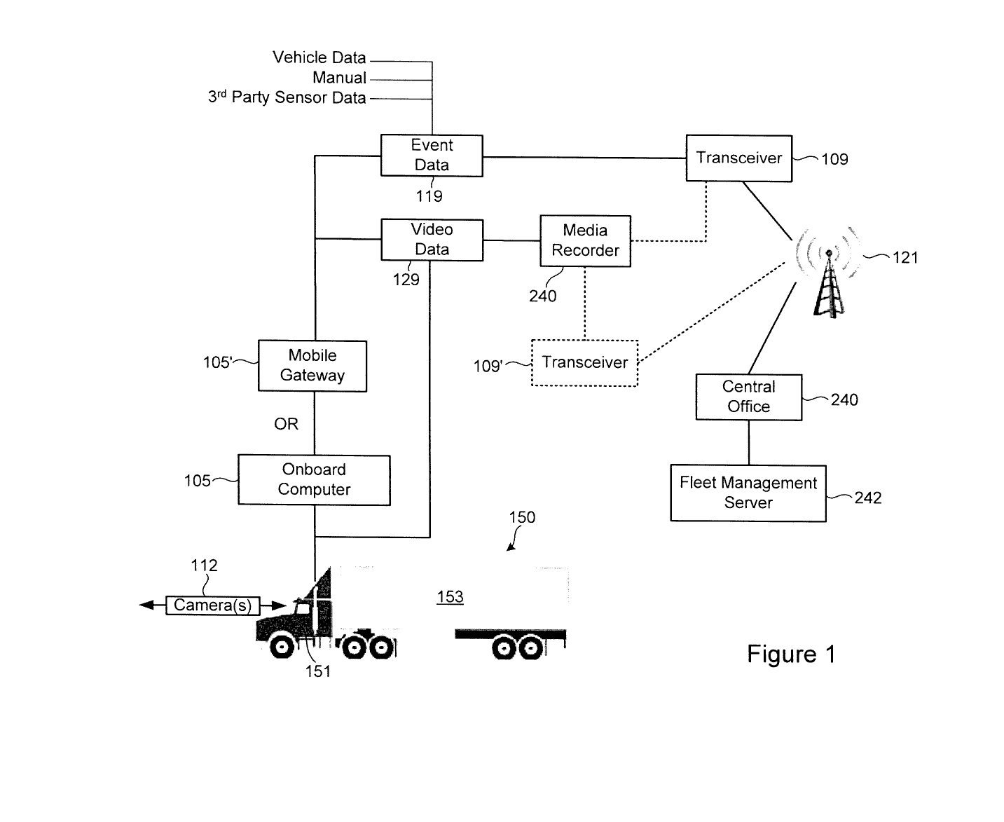

FIG. 1 illustrates a system for implementing video intelligence capture in accordance with various embodiments of the present disclosure. Video intelligence capture represents one of several processes that can be implemented in accordance with the system shown in FIG. 1. Several distinct processes involving the capture and/or analysis of video acquired at a commercial vehicle will be described herein, each of which can be implemented individually or in combination with other processes to provide for enhanced functionality and features.

According to the embodiment shown in FIG. 1, a commercial vehicle 150 includes a tractor 151 and a trailer 153. The tractor 151 includes a forward-looking camera 112. In some embodiments, the tractor 151 includes a driver-looking camera 112 in addition to a forward-looking camera 112. One or more cameras 112 can be mounted at different locations of the tractor 151 and/or trailer 153 according to various embodiments. Mounted at the tractor 151, typically within the cab, is either an onboard computer 105 or a mobile gateway 105′, both of which are described in greater detail hereinbelow. In general, the onboard computer 105 and the mobile gateway 105′ are configured to monitor for occurrence of a variety of predetermined events (e.g., safety-related events) by monitoring vehicle computer data, camera data (which may include audio data), and other sensor data. For example, an “improper passing” event or an “improper turn” event can be detected using video produced by the forward-looking camera 112. A “texting while driving” event can be detected using video produced by the driver-looking camera 112. A “roll instability” event can be detected using an accelerometer or other type of rate sensor, for example. Sudden acceleration, sudden deceleration, and speeding can be detected using vehicle computer data. A variety of predetermined events that trigger event data and/or video capture are contemplated, additional examples of which are described hereinbelow.

In response to detecting a predetermined event, which may be a manual event initiated by the driver of the vehicle 150, event data 119 is captured by the onboard computer 105 or the mobile gateway 105′. Video data 129 produced by the cameras 112 is also captured and recorded by a media recorder 240. In some embodiments, video data 129 is transmitted to the media recorder 240 along one or more connections (e.g., HDMI) that bypass the onboard computer 105 or mobile gateway 105′, with the media recorder 240 being communicatively coupled to the onboard computer 105 or mobile gateway 105′ for control purposes. In other embodiments, the media recorder 240 is a component of the onboard computer 105 or mobile gateway 105′.

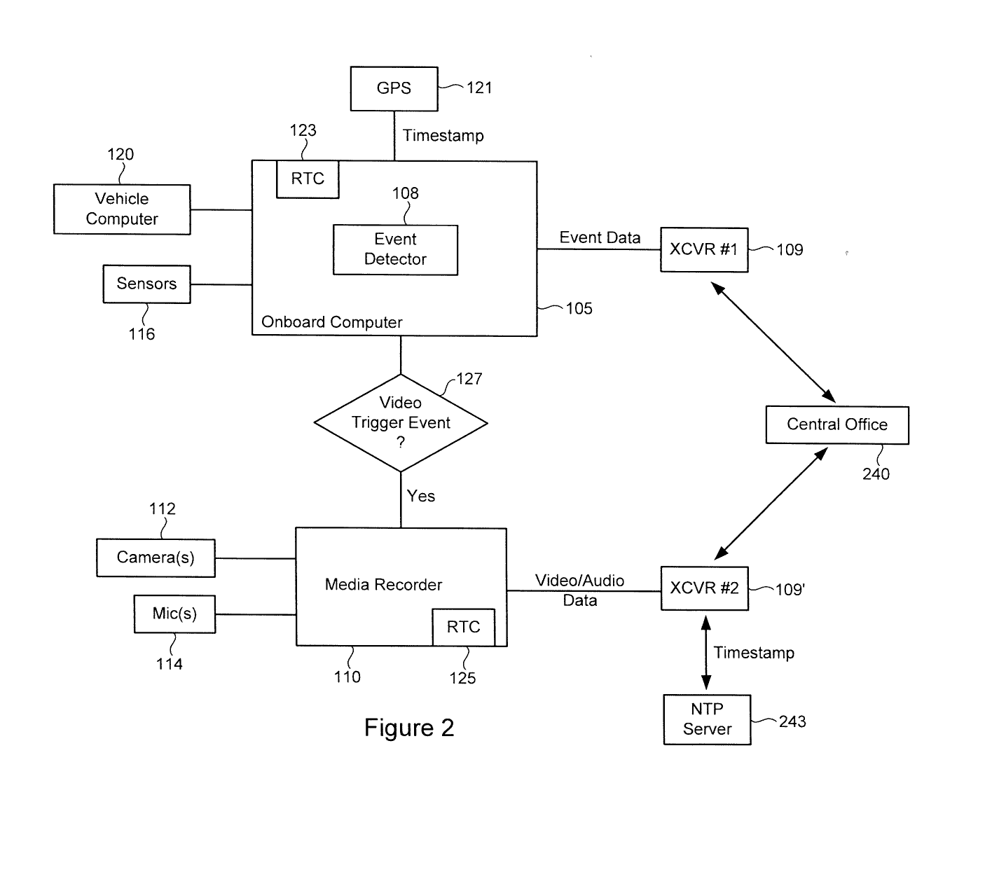

It is noted that for minor events, video data may not be recorded. It is understood that video data requires significant resources for storage and transmission relative to alphanumeric data (e.g., event data). As such, video data for minor events can be, but need not be, captured for storage and subsequent transmission and analysis. In some embodiments, the event data 119 and the video data 129 are communicated to the central office via a transceiver 109, such as a cellular transmitter/receiver or a satellite transmitter/receiver. In other embodiments, and is described in detail with reference to FIG. 2, the event data can be communicated to the central office 240 via a first transceiver 109, and the video data 129 can be transmitted to the central office 240 via a second transceiver 109′. A fleet management server 242 at the central office 240 processes and manages the event data 119 and the video data 129 in accordance with various methodologies described herein.

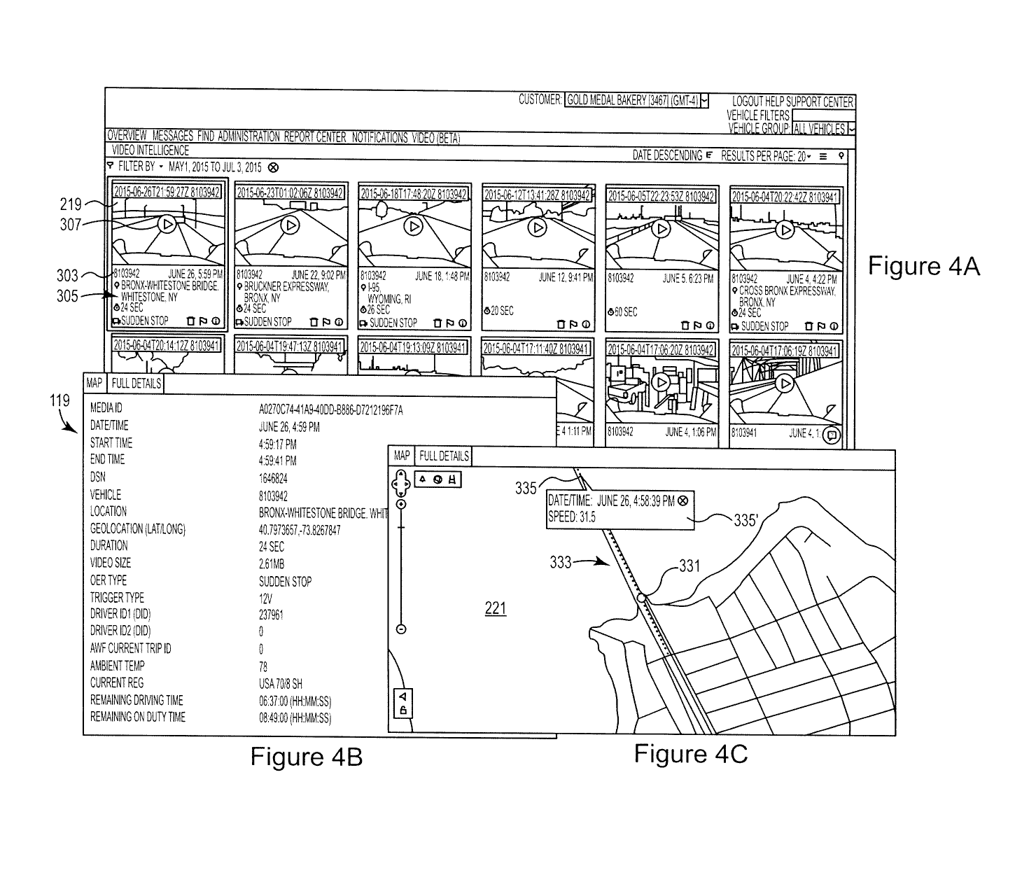

The following is a description of an end-to-end workflow process that involves the video intelligence capture system and methodology described with reference to FIG. 1. Each of the following workflow processes can be implemented as a stand-alone process or can be combined with other processes to provide for enhanced features and functionality. A video intelligence capture process involves capture of event data 119 and video data 129 at individual commercial vehicles 150 and transmission of this data to the central office 240. A fleet management server 242 is configured to organize individual video clips for presentation in a video review portable accessible by remote users, an example of which is shown in FIGS. 4A-4C. Each video clip can be annotated with declaration data, which is information concerning the type, date/time, and geolocation of the event, as well as other information, for which the video clip was recorded. Geolocation (latitude/longitude) data is preferably part of the event data 119 and/or video data 129 received from the vehicles 150.

The fleet management server 242 is configured to create a map that shows where each event occurred and, according to some embodiments, includes GPS breadcrumb data. The GPS breadcrumb data includes detailed event data acquired at regular intervals (e.g., one or two second intervals), with each GPS breadcrumb having its own geolocation location that can be shown as a point (breadcrumb) on the map (see, e.g., FIG. 4C). For example, a given event may result in capture of event data 119 and video data 129 for a 24 second capture period surrounding the event (12 seconds before and 12 seconds after the event). For each one or two second interval of the 24 second capture period, detailed event data is recorded and associated with its geolocation data. As such, the video review portal can provide a comprehensive visual view (video clip and map) of an event, in addition to providing detailed textual and graphical information, for internal and external users (e.g., fleet safety managers).

Another component of the end-to-end workflow process involves driver behavior analysis and scoring. According to various embodiments, driver behavior is analyzed and scored in accordance with standards promulgated by a governmental inspection agency (GIA), such as the U.S. Department of Transportation (USDOT). A departure from appropriate driver behavior is referred to herein as a violation. For some events, a driver violation can be scored using an algorithm in an automated fashion (i.e., via a processor without human review). For other events, the occurrence of a driver violation requires human review of video data associated with a particular event. Whether accomplished algorithmically or via human review, driver violations are scored in accordance with standards promulgated by a governmental inspection agency.

According to various embodiments, driver violations are analyzed and scored in accordance with the methodology specified in the Carrier Safety Measurement System (CSMS) established by the Federal Motor Carrier Safety Administration (FMCSA), along with that of the corresponding Federal Motor Carrier Safety Regulation (FMCSR) and/or Hazardous Material Regulation (HMR) sections. The FMCSA is an agency in the USDOT that regulates the trucking industry in the United States. The primary mission of the FMCSA is to reduce crashes, injuries, and fatalities involving large trucks and buses. The Compliance, Safety, Accountability (CSA) program is the cornerstone of the FMSCA's compliance and enforcement initiative. The CSA program oversees carriers' safety performance through roadside inspections and crash investigations, issuing violations when instances of noncompliance with safety regulations are uncovered. The FMCSA partners with state law enforcement agencies to identify unsafe, high-risk carriers using a driver scoring system known as the Safety Measurement System (SMS). The SMS provides a methodology for calculating SMS safety scores for individual drivers, more commonly referred to as CSA scores.

The term driver behavior as used herein generally includes risky or high-risk behavior exhibited by a driver, such as the various forms of unsafe driving described in this disclosure. For purposes of simplicity, driver behavior scoring according to the SMS/CSA methodology is referred to herein as scoring consistent with governmental inspection authority standards. It is understood that driver violations can be scored in accordance with standards promulgated by a governmental inspection agency of a foreign country for vehicles operating in such foreign country. It is further understood that some degree of scoring customization is contemplated, such as the use of custom scoring categories that are unique to a particular carrier. Such custom scoring can be integrated with scoring that is consistent with governmental inspection authority standards. It is also understood that driver scoring can be based on an industry accepted scoring system that may or may not be consistent with a governmental inspection authority system.

When a DOT or state law enforcement officer issues a ticket or citation to a commercial vehicle driver for a driving or safety violation, CSA scoring for the driver is recorded for the incident and uploaded to a publicly available website. This data is usually publically available within one or two days of the incident. It can be appreciated that the number of DOT and state law enforcement partners is very small relative to the millions of commercial vehicles/commercial driver license holders nationwide. As such, only a small percentage of actual driver violations are ever reported in the CSA scoring database.

Embodiments of the present disclosure provide for CSA equivalent scoring of driver behavior for all events that are detected by the onboard computer 105 or mobile gateway 105′. Embodiments of the disclosure can serve the function of a virtual DOT or state law enforcement officer who is continuously monitoring each vehicle 150 and scoring driver behavior in response to detected events in accordance with GIA standards.

In accordance with various embodiments, the fleet management server 242 is configured to provide driver behavior scoring consistent with GIA standards based on event data 119 and video data 129 received from commercial vehicles 150. The fleet management server 242 is also configured to provide driver CSA scoring acquired from a government CSA score database. In this way, driver behavior scoring based on event data 119 and video data 129 acquired from an onboard computer or mobile gateway is normalized to be equivalent with CSA scoring.

A further component of the end-to-end workflow process involves review of an event by a driver soon after the event. According to various embodiments, an in-cab and/or driver device (e.g., tablet, smartphone) is notified when an event packet produced by the fleet management system 242 for a detected event is available for review. At the next stop, the driver can review the event packet on the in-cab or driver device. The event packet typically includes event data and a video clip acquired for the event. In some embodiments, driver scoring for the event is included within the event packet and can be reviewed by the driver. After reviewing the event packet, a safety manager can conduct a telephone discussion or face-to-face meeting with the driver as part of a review or coaching session. For example, the safety manager can review the event, video, and scoring data from his or her office, while at the same time the driver can review the same information using the in-cab or driver device. At the conclusion of the review or coaching session, the safety manager can record comments, instructions, and remedial action to be taken by the driver.

Turning now to FIG. 2, there is illustrated a block diagram of a system for communicating event data and video data for the vehicle using separate transceivers in accordance with various embodiments. In the embodiment shown in FIG. 2, an onboard computer 105 (or optionally a mobile gateway) is configured to communicate event data to a central office 240 via a first transceiver 109. A media recorder 110 is configured to communicate video and optionally audio to the central office 240 via a second transceiver 109′. For example, the onboard computer 105 can include its own cellular radio 109 with its own SIM card and service plan. Likewise, the media recorder 110 can include its own cellular radio 109′ with its own SIM card and service plan. Use of a separate cellular link by the media recorder 110 allows for tailoring the link and service plan specifically for image/video communication between the vehicle and the central office 240.

In the embodiment shown in FIG. 2, the onboard computer 105 is coupled to a vehicle computer 120 and one or more sensors 116. The onboard computer 105 includes an event detector 108 and a real-time clock (RTC) 123. The media recorder 110 is shown coupled to one or more cameras 112 and optionally to one or more microphones 114. The media recorder 110 includes an RTC 125. The RTC 123 of the onboard computer 105 is updated on a regular basis using timestamp data produced by a GPS sensor 121. For example, the RTC 123 can be updated every 5, 10 or 15 minutes (e.g., a configurable time interval) using the GPS sensor timestamp. The media recorder 110 updates its RTC 125 by synchronizing to timestamp data received from a Network Time Protocol (NTP) server 243. The NTP server 243 is accessed by the media recorder 110 via transceiver 109′. The media recorder 110 can update its RTC 125 using the NTP server timestamp periodically, such as every 5, 10, or 15 minutes (e.g., a configurable time interval), for example. The frequency of RTC updating by the onboard computer 105 and the media recorder 110 can be selected to achieve a desired degree of time base accuracy. It is noted that the onboard computer 105 can also update its RTC 123 using timestamp data received from an NTP server 243 rather than from the GPS sensor 121 (e.g., at times when the GPS sensor is out of satellite range).

An important consideration when communicating event and video data via separate transceivers is time synchronization. Because event data is communicated through a cellular link separate from that used to communicate the video data, proper time synchronization is required so that event and video data associated with a specific vehicle event can be properly associated at the central office 240. Because the RTCs 123 and 125 are frequently updated using highly accurate time bases (e.g., NTS server, GPS sensor), the timestamps included with the event data and the video data for a given event can be synchronized at the central office 240 with high accuracy. The central office 240 can rely on the accuracy of the event data and video data timestamps when associating the disparate data acquired from the two transceivers 109 and 109′.

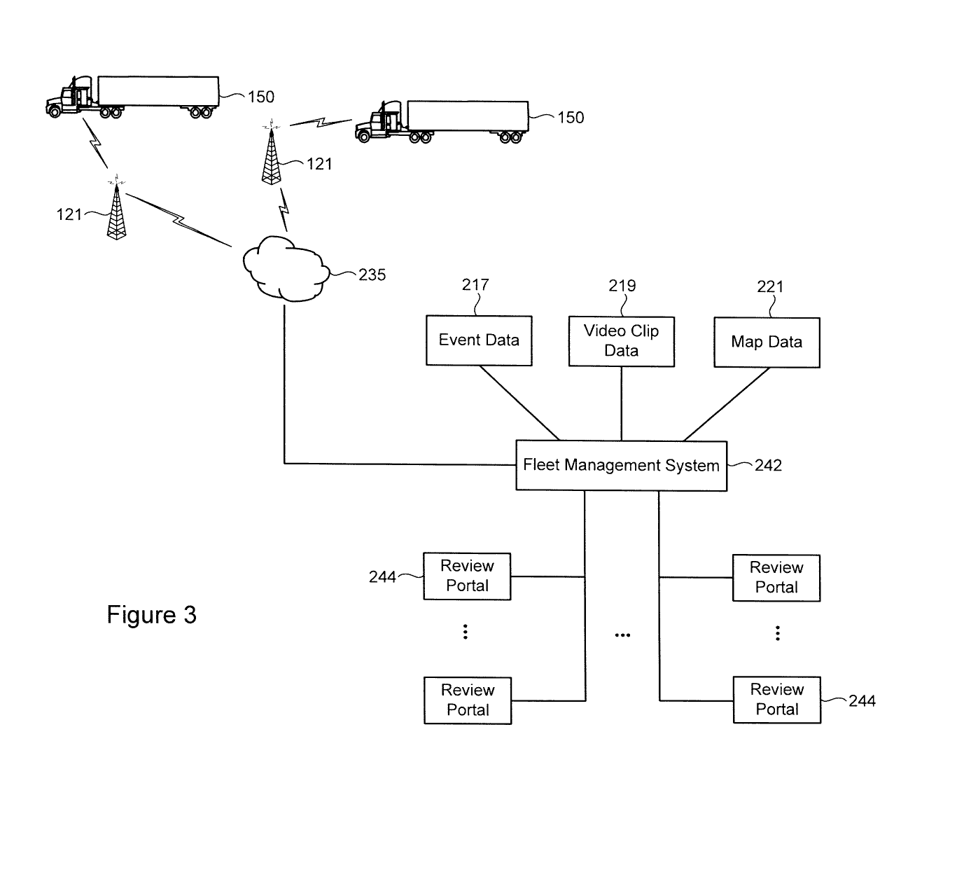

FIG. 3 is a block diagram of a system configured to implement video intelligence capture and evaluation in accordance with various embodiments. FIG. 3 shows a fleet management system 242 configured to receive event data and video data from a multiplicity of commercial vehicles 150. It is noted that the term video data is intended to refer to image capture data, such as video and still photographic image data, as well as audio data. It is understood that video data may exclude audio data. Data acquired at each vehicle 150 is transmitted, via a single cellular radio or multiple radios as previously discussed, for reception by a central office to which the fleet management system 242 is coupled. Telecommunication infrastructure, such as base stations 121 and the Internet 235, is typically used to effect communication between the vehicles 150 and the fleet management system 242. In cases where cellular communication is not available, a satellite link can be used.

The data acquired from the vehicles 150 and managed by the fleet management system 242 includes event data 217, video clip data 219, and map data 221. As was previously discussed, the event data 217 and video clip data 219 for a specific event occurring at a specific vehicle 150 are associated with one another based on vehicle ID (or other identifying information) and timestamp data. The fleet management system 242 is configured to associate disparate data for each unique vehicle event and make this data available to users via a review portal 244. A review portal 244 can be implemented using a browser or an app running on a user's laptop, tablet, or smartphone and a secured connection established between the user's device and the fleet management system 242. FIGS. 4A-4C illustrate various disparate information that can presented to a user via a review portal 244.

FIG. 4A shows a series of video clips 219 each associated with a different vehicle event. The video clips 219 can be associated with the same vehicle or different vehicles of a fleet. Generally, the user of a review portal 244, such as a safety manager, is granted access to video clips 219 and related data for vehicles of a particular fleet (or a subset of vehicles of the fleet). Each video clip 219 is preferably annotated with declaration data 305, which includes various types of identifying and event-related information. For example, each video clip 219 can include the vehicle ID 303, date and time 304 of the event, location and/or geolocation of the event, duration of the video clip, and the type of event that caused creation of the video clip 219. For the activated video clip 219 shown in FIG. 4A, the vehicle ID is 8103943, the date/time is Jun. 25, 2015 at 4:59 PM, the location is the Bronx-Whitestone Bridge, Whitestone, N.Y., the duration of the video clip is 24 seconds, and the event type is Sudden Stop.

The user can play a video clip 219 of interest by moving a cursor of a user interface to a particular video clip 219 and then activating the play button 307. The video clip 219 can be presented in a full or partial screen of the display, and can include audio of the event. The review portal 244 allows the user to click on a tab to reveal full details of the event associated with the selected video clip 219, an example of which is shown in FIG. 4B. FIG. 4B shows event data 119 associated with the selected video clip 219. The event data 119 includes a rich amount of data associated with the event, such as vehicle ID, driver ID, location and geolocation, event type, ambient temperature, and the driver's hours of service data. This data and other data shown in FIG. 4B is provided for purposes of illustration, it being understood that other information may be included on the screen.

The review portal 244 also allows the user to click on a tab to present a map 221 of where the event occurred, an example of which is shown in FIG. 4C. The fleet management system 242 combines mapping data with event data to produce the composite map shown in FIG. 4C. The map 221 shows the location 331 where the event occurred, and further includes GPS breadcrumbs in advance of, and subsequent to, the event location 331. As was previously described, the GPS breadcrumbs represent snapshots of event data taken at regular intervals, such as every one or two seconds, for example. Each GPS breadcrumb contains event data and can also contain geolocation data. The user can move the cursor to hover over a breadcrumb, such as GPS breadcrumb 335, to activate a dialogue box 335′ which displays various types of event data and optically geolocation data. Typically, the content of the video clip data 219 begins at the first GPS breadcrumb preceding the event location 331 and terminates at the last GPS breadcrumb subsequent to the event location 331.

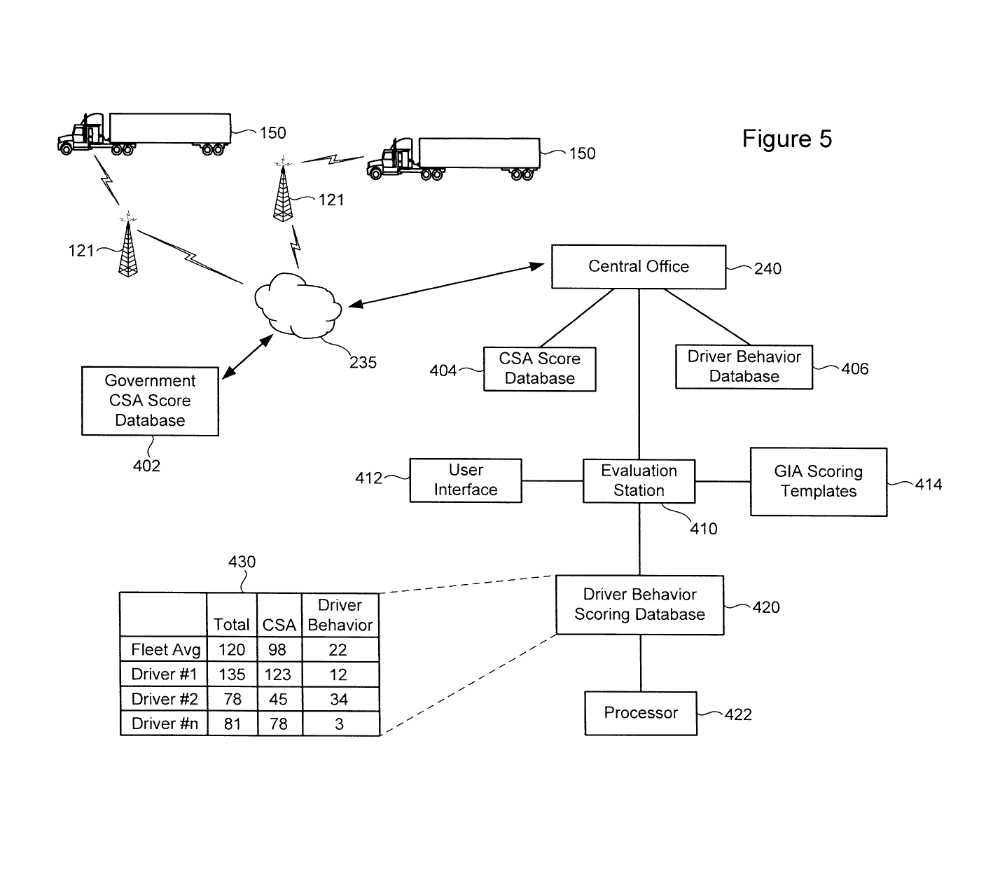

FIG. 5 is a block diagram of a system for scoring driver behavior in accordance with various embodiments. According to the embodiment shown in FIG. 5, event and video data is acquired at a central office 240 from a multiplicity of commercial vehicles 150, typically via cellular and Internet infrastructure 121, 235. The central office 240 includes a CSA score database 404 and a driver behavior database 406. The CSA score database 404 stores CSA scores for a multiplicity of drivers obtained from the government CSA score database 402. The driver behavior database 406 stores event data and video data captured for individual events occurring at each of the vehicles 150.

The system shown in FIG. 5 further includes an evaluation station 410 coupled to a user interface 412. The evaluation station 410 is used to conduct driver behavior scoring, the results of which are stored in a driver behavior scoring database 420. An evaluator uses the evaluation station 410 to review video clips for possible violations and to score driver violations in accordance with GIA scoring templates 414. The GIA scoring templates 414 allow the evaluator to select predefined violations that are observed in the video clip and assign a severity rating (e.g., severity points) to each observed violation. The severity ratings assigned to each violation via the GIA scoring templates 414 are consistent with those specified in the USDOT's SMS/CSA scoring methodology. Preferably, the severity ratings are automatically assigned for each observed violation, and cannot be altered by the evaluator. In this way, driver behavior scoring remains consistent with the SMS/CSA scoring methodology.

For example, an evaluator may determine from reviewing a video clip obtained from a forward-looking camera that the driver was following too closely to the vehicle immediately ahead. The evaluator can click a box indicating a “following too close” violation, and the equivalent CSA score (e.g., 5 in this example) for this violation is attributed to the driver of the vehicle. By way of further example, the evaluator may determine from reviewing a video clip obtained from a driver-looking camera that the driver was texting while driving. The evaluator can click a box indicating that a “texting while driving” violation was observed, and the equivalent CSA score (e.g., 10 in this example) for this violation is attributed to the driver of the vehicle. It is noted that more than one violation can be attributed to a driver for the same event.

FIG. 5 shows representative output 430 that can be produced by a processor 422 using scoring data stored in the driver behavior scoring database 420 according to various embodiments. The output 430 can represent data presented on a display or printed as a report. The output 430 shows a CSA score, a driver behavior score, and a total score for each of a number of drivers (Drivers #1-#n), such as all or a subset of drivers of a fleet. Also shown in output 430 is a fleet average CSA score, driver behavior score, and total score. The database 420 can be sorted based on any of the columns, with drivers having the highest total scores presented at the top of the output 430 as a default, for example. The output 430 shown in FIG. 5 provides immediate identification of drivers having the highest frequency and/or severity of violations. The ability to quickly and reliably identify problem drivers allows management to focus attention and training on the worst offenders.

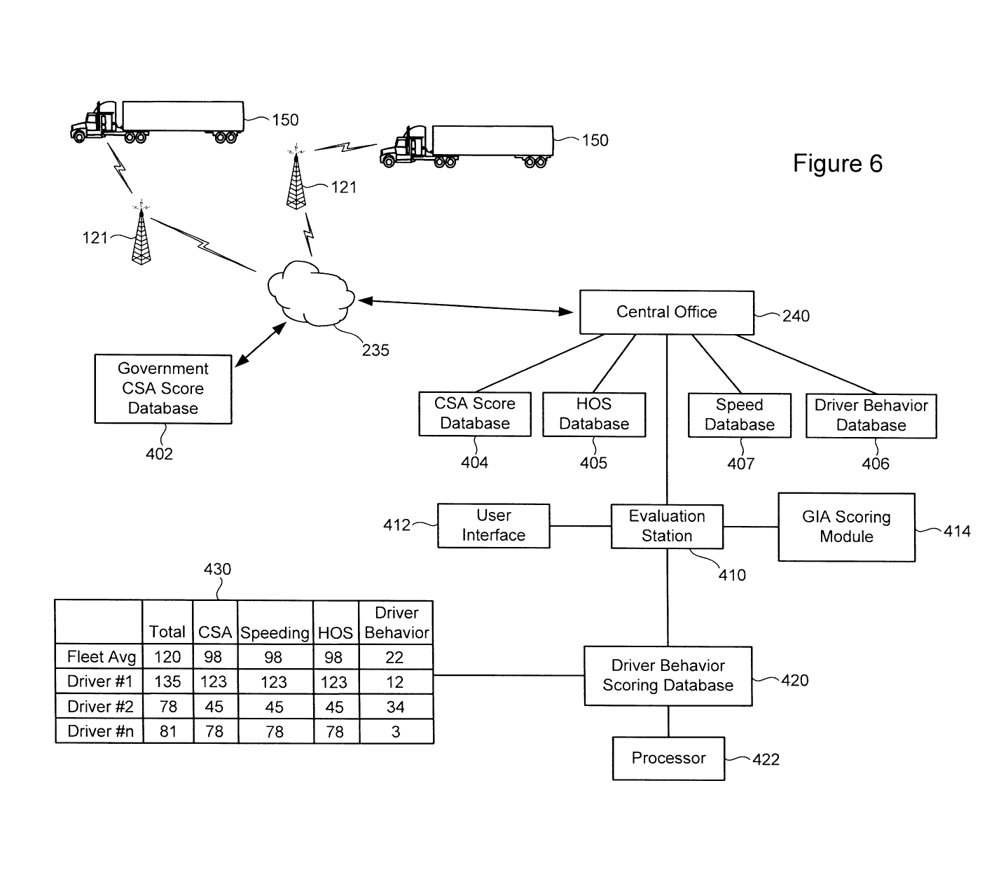

FIG. 6 is a block diagram of a system for scoring driver behavior in accordance with other embodiments. The embodiment shown in FIG. 6 is similar to that illustrated in FIG. 5, but includes additional driver behavior scoring categories. In the embodiment shown in FIG. 6, the central office 240 includes the CSA score database 404 and driver behavior database 406 shown in FIG. 5, and further includes an Hours of Service (HOS) database 405 and a speed database 407. HOS data is managed by and acquired from the onboard computer or mobile gateway of each vehicle 150. HOS data is typically captured as part of the event data and stored in the HOS database 405. It is noted that violation of HOS rules as detected by the onboard computer or mobile gateway can constitute an event which initiates transmission of HOS data to the central office 240.

HOS regulations are specified by the FMCSA for both property-carrying drivers and passenger-carrying drivers. According to FMCSA rules, property-carrying drivers may drive a maximum of 11 hours after 10 consecutive hours off-duty. Such drivers may not drive beyond the 14^{th} consecutive hour after coming on duty, following 10 consecutive hours off-duty. Off-duty time does not extend the 14-hour period. Other HOS regulations involve rest breaks, in which property-carrying drivers may drive only if eight hours or less have passed since the end of the driver's last off-duty or sleeper berth period of at least 30 minutes. Further HOS regulations specify that property-carrying drivers may not drive after 60/70 hours on duty in 7/8 consecutive days. Such drivers may restart a 7/8 consecutive day after taking 34 or more consecutive hours off-duty. Most of the HOS violations have a severity rating of 7.

Speed data is acquired from the onboard computer or mobile gateway of each vehicle 150, and is transmitted to the central office 240 typically as part of event data and stored in the speed database 407. It is noted that violation of speed rules as detected by the onboard computer or mobile gateway can constitute an event which initiates transmission of speed data to the central office 240. Speeding regulations are specified by the FMCSA and different severity ratings are assigned to violations based on the magnitude of the speeding offense. According to the USDOT's SMS/CSA scoring methodology, speeding 6 to 10 MPH over the posted speed limit has a severity rating of 4, while speeding 11 to 14 MPH over the speed limit has a severity rating of 7. Speeding 15 or more MPH over the speed limit has a severity rating of the 10.

In the case of HOS and speed infractions, human evaluation is not required to score these violations. Detection of HOS and speed violations can be performed algorithmically by the fleet management server, the evaluation station 410 or other processor coupled to HOS database 405 and speed database 407. For example, speed data for a particular event is captured from the onboard computer or mobile gateway and communicated to the central office 240. Using the geolocation data associated with the event, the speed data can be compared to the posted speed limit for the geolocation to determine the magnitude of the speeding offense. For example, GPS breadcrumbs containing event data (e.g., ECM speed data) can be transmitted from the vehicles to the central office 240 or a third party server. The geolocation and speed data of the GPS breadcrumbs can then be matched against mapping data that includes posted speed limits along the roadways implicated by the geolocation data. The central office 240 or third party server can then generate a report or file that includes geolocation, actual speed, and posted speed limits that can be used to detect speeding violations by the vehicles/drivers. If the processor determines that the driver was speeding 6 to 10 MPH over the posted speed limit, a severity rating of 4 is assigned to the driver. If the processor determines that the driver was speeding 11 to 14 MPH over the speed limit, a severity rating of 7 is assigned to the driver. If the processor determines that the driver was speeding 15 or more MPH over the speed limit, a severity rating of 10 is assigned to the driver. In a similar manner, the processor can determine from the HOS data received from the vehicle which HOS rule has been violated and assign the appropriate severity rating to the driver for the HOS violation.

FIG. 6 also shows representative output 430 produced by a processor using scoring data stored in the driver behavior scoring database 420. The output 430 of FIG. 6 shows a CSA score, a speeding score, an HOS score, a driver behavior score, and a total score for each of a number of drivers (Drivers #1-#n). Also shown is a fleet average CSA score, speeding score, HOS score, driver behavior score, and total score. The database 420 can be sorted based on any of the columns, with drivers having the highest total scores presented at the top of the output 430 as a default, for example. The output 430 shown in FIG. 6 provides immediate identification of drivers having the highest frequency and/or severity of violations.

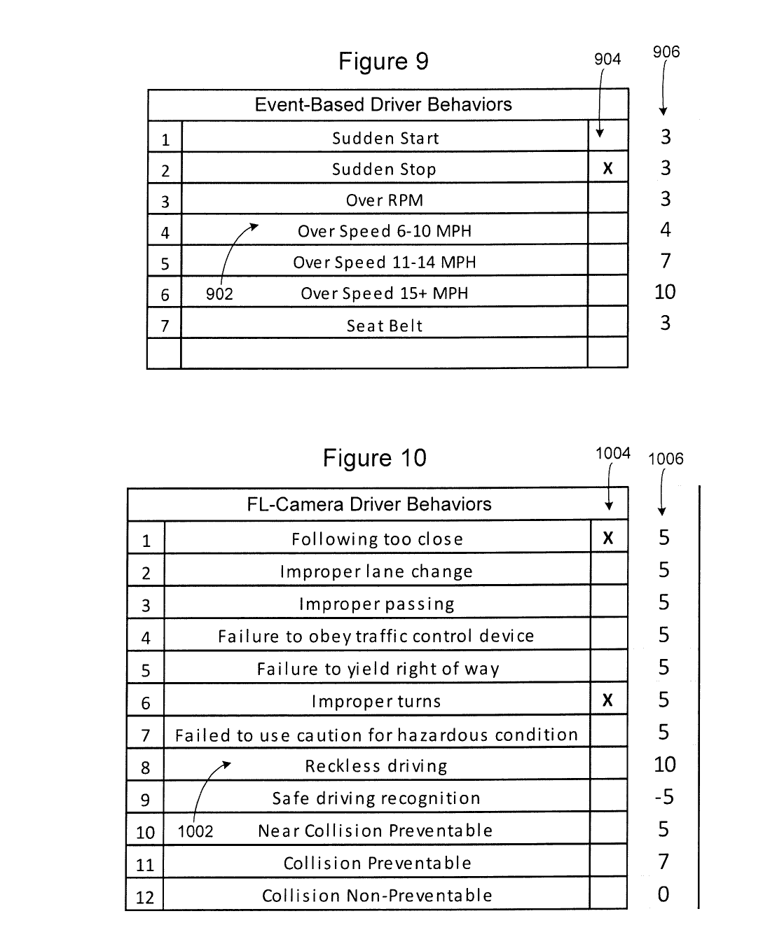

According to some embodiments, the system shown in FIG. 6 (and other figures) can be configured to provide driver scoring data similar to that shown in output 430 based solely on algorithmically determined driver behavior. Some system implementations may not include human evaluation of video clips. In such implementations, significant value can be provided by algorithmically processing event data and producing output 430 that includes only the processor-determined driver behavior. In the context of FIG. 6, such a system implementation would produce an output 430 that includes all of the scoring data except for some of the driver behavior data (e.g., the driver behavior data that can determined only through human evaluation). However, as noted hereinbelow, a significant amount of driver behavior data can be evaluated and scored based on event-driven data acquired from a vehicle's onboard computer or mobile gateway. Such event-drive data includes data associated with Sudden Start, Sudden Stop, Over RPM, Over Speed, and Seat Belt events (see, e.g., driver behaviors listed in FIG. 9). Moreover, some driver behavior (e.g., “following too close” and “improper lane change”) can be detected using sensors at the vehicle (e.g., a lane departure sensor or a following distance sensor described hereinbelow). As such, the output 430 shown in FIG. 6 that does not involve human evaluation of video clips can still include a significant amount of driver behavior scoring.

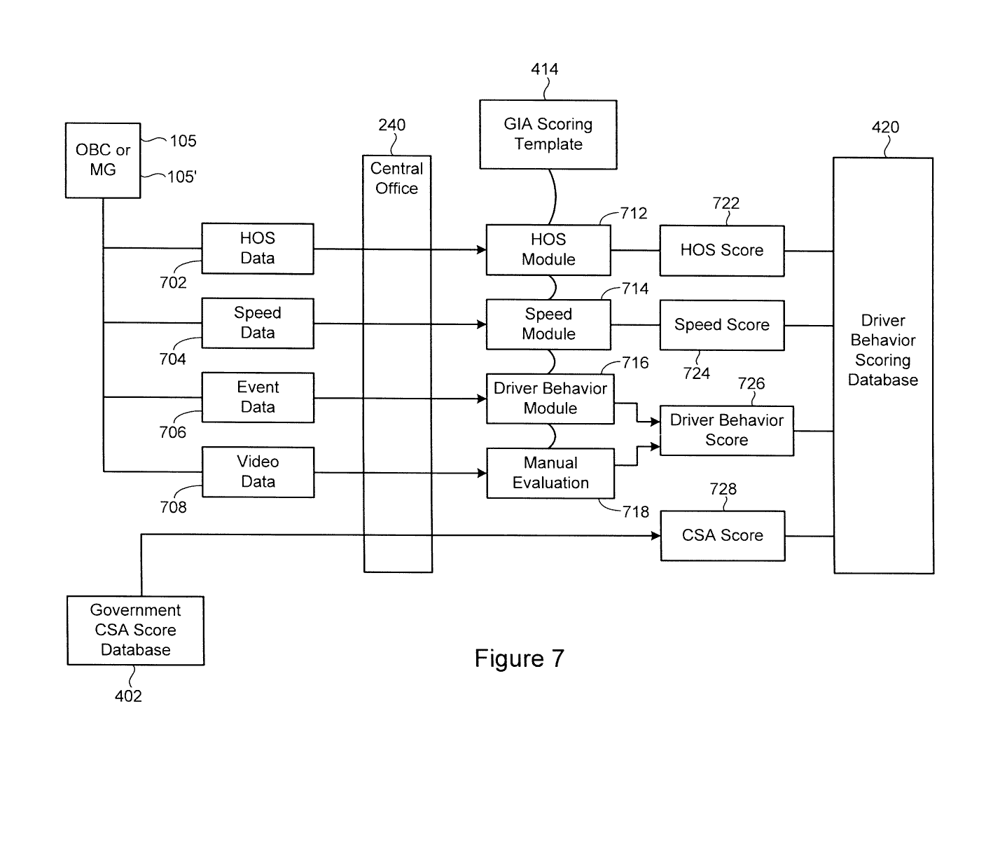

FIG. 7 is a block diagram of a system for scoring driver behavior in accordance with various embodiments. The embodiment shown in FIG. 7 provides a detailed view of driver behavior scoring based on data acquired from a multiplicity of vehicles. In the embodiment shown in FIG. 7, various types of data are acquired from the onboard computer 105 or mobile gateway 105′ of a multiplicity of vehicles. The various types of data include HOS status 702, speed data 704, event data 706, and video data 708 (which may also include audio data). These data are transmitted to the central office 240. In some embodiments, the HOS, speed, and event data 702, 704, 706 can be transmitted via a first transceiver at the vehicle, and the video data 708 can be transmitted via a second transceiver at the vehicle, as was discussed previously.

A number of different processing modules are provided at the central office 240 for processing the various types of data received from the onboard computer 105 or mobile gateway 105′. These modules include an HOS module 712, a speed module 714, and a driver behavior module 716. A single processor or multiple processors can be employed to implement the functionality of the modules 712, 714, and 716. Each of the modules 712, 714, 716 is configured to algorithmically detect violations using the received data 702, 704, 706 and assign severity ratings to each violation using appropriate GIA scoring templates 414. A manual evaluation module or station 718 is provided to allow for manual analysis and scoring of video data 708, such as video data acquired from a forward-looking camera and/or a driver-looking camera installed at the vehicle. The HOS module 712 is configured to analyze the HOS data 702 and, in response to detecting a violation, apply the appropriate severity rating from the GIA scoring template 414 to compute an HOS score 722. The speed module 714 is configured to analyze the speed data 704 and, in response to detecting a violation, apply the appropriate severity rating from the GIA scoring template 414 to compute a speed score 724.

As can be seen in FIG. 7, the driver behavior score 726 can be computed from analyses performed by the driver behavior module 716 and at the manual evaluation station 718. Some of the event data 706 (see, e.g., FIGS. 9 and 12) contains information that can be algorithmically processed by the driver behavior module 716 to detect a violation. For such data, the driver behavior module 716 is configured to analyze the event data 706 and, in response to detecting a violation, apply the appropriate severity rating from the GIA scoring template 414 to compute a driver behavior score 726. As was previously described, and is described in greater detail hereinbelow, manual evaluation of the video data 708 can result in identification of one or more violations observed by a human evaluator via the manual evaluation station 718. By appropriately checking the identified violations presented on a display at the evaluation station 718, the GIA scoring template 414 applies the appropriate severity rating to compute a driver behavior score 726.

In some embodiments, calculation of the various scores can be adjusted according to the age of the violations used to compute the scores. The SMS/CSA scoring methodology provides for an effective reduction of violation scores based on age of violations. According to the SMS/CSA system, a time weight of 1, 2, or 3 is assigned to each applicable violation based on how long ago a violation on the inspection was recorded. Violations recorded in the past 12 months receive a time weight of 3. Violations recorded between 12 and 24 months ago receive a time weight of 2. All violations recorded earlier (older than 24 months but within the past 36 months) receive a time weight of 1. This time weighting places more emphasis on recent violations relative to older violations. A time and severity weighted violation is a violation's severity weight multiplied by its time weight. Each of the scoring modules shown in FIG. 7 can be configured to calculate time and severity weighted violations according to some embodiments.

As is further shown in FIG. 7, a CSA score 728 is received at the central office 240 by way of a government CSA scoring database 402. The HOS, speed, driver behavior, and CSA scores 722, 724, 726, 728 are stored and managed by a driver behavior scoring database 420, which is serviced by a processor (e.g., a processor of a fleet management system or server). The driver behavior scoring database 420 can be accessed by a fleet management system 242, such as that shown in FIG. 3. Users can access the driver behavior scoring database 420 via a review portal 244 coupled to a fleet management system 242.

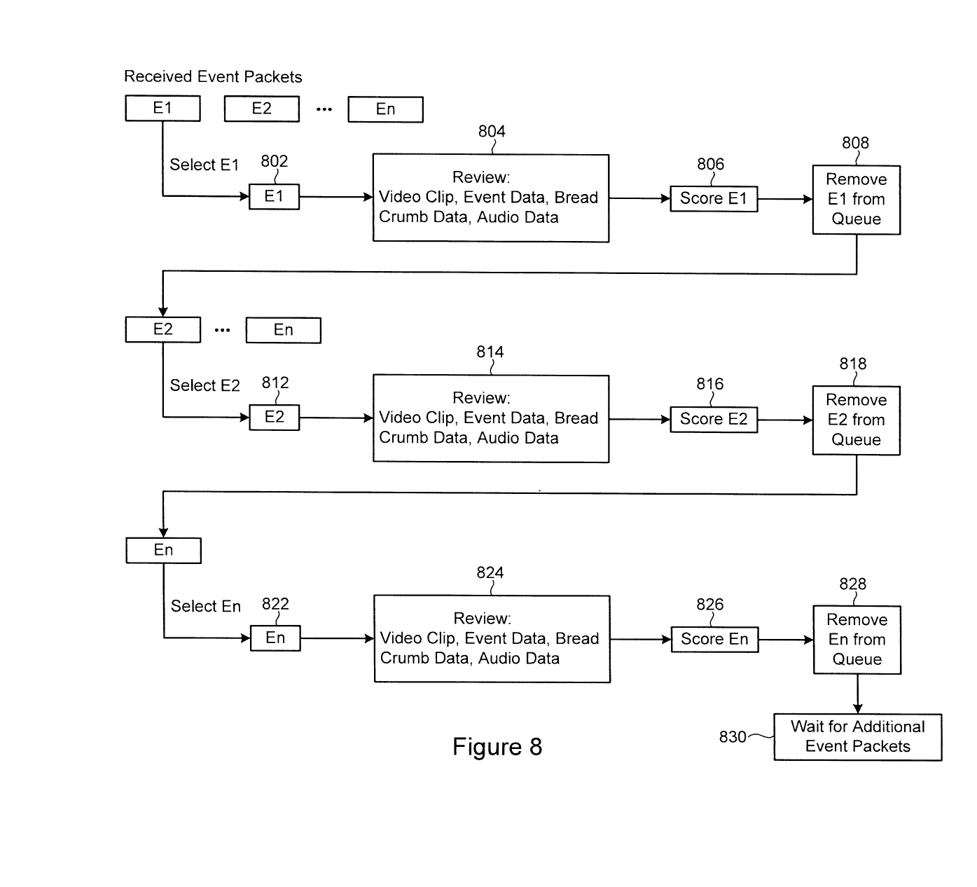

FIG. 8 illustrates a method of manually evaluating video clips received from an onboard computer or mobile gateway provided at a multiplicity of commercial vehicles in accordance with various embodiments. In some implementations, the evaluator may be an employee of a customer/fleet. In other implementations, the evaluator may be an employee of a third party evaluation service. In the embodiment shown in FIG. 8, a number of event packets, E1, E2 . . . En, are received in a queue at an evaluation station. Each of the event packets includes at least a video clip associated with an event occurring during vehicle operation. Generally, the event packets include event data in addition to the video clip, and may further include audio data. In some embodiments, the fleet management system generates GPS breadcrumb data and mapping data associated with the event, such as that described previously with reference to FIG. 4C. The evaluation station includes a computer or other processor having a user interface (e.g., a display, a mouse, a keyboard) configured to implement an event review procedure.

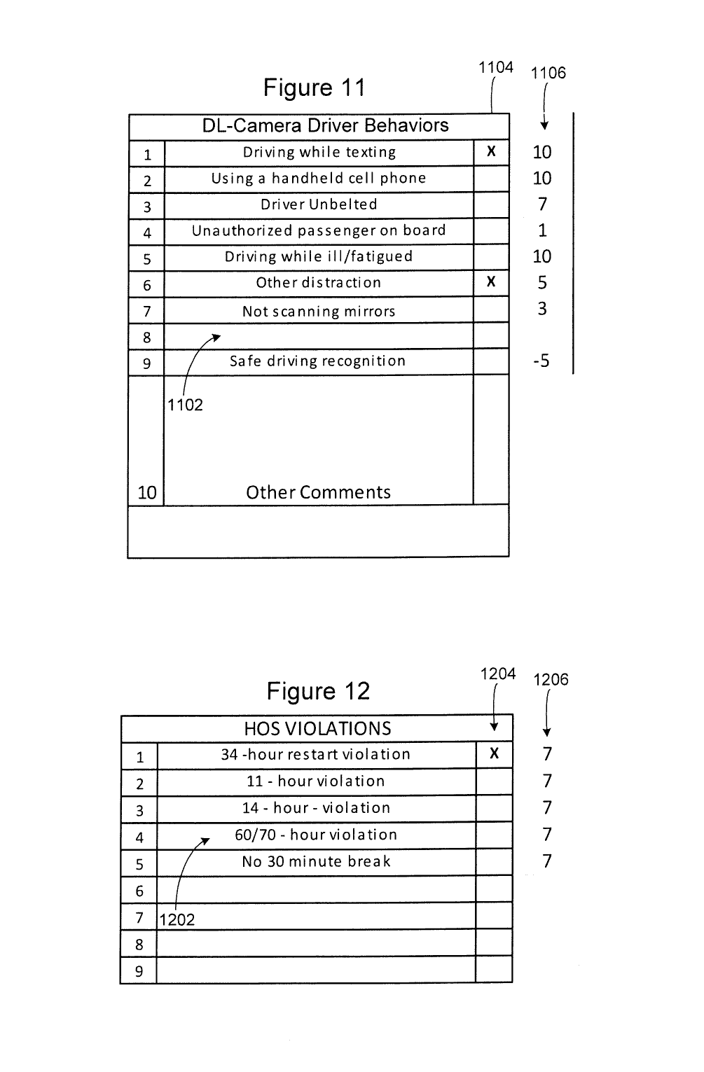

According to a representative review procedure, the evaluator selects 802 (e.g., using a mouse) one of the received event packets in the queue of event packets (e.g., presented on the display), such as event packet E1 shown in FIG. 8. The video clips 219 shown in FIG. 4A, for example, can be representative of a queue of event packets that are waiting evaluation. The evaluator can review 804 the video clip of event packet E1 presented on the display by clicking a play button presented on the video clip. The evaluator can also review other related data that is associated with the video clip, such as event data, breadcrumb data, and audio data. After reviewing the event packet E1, the evaluator scores 806 the driver's behavior using one or more GIA scoring templates, such as those shown in FIGS. 9-12. The GIA scoring template shown in FIG. 9 lists a number of event-based driver behaviors 902. The GIA scoring template shown in FIG. 10 lists a number of driver behaviors 1002 that can be captured by a forward-looking camera. The GIA scoring template shown in FIG. 11 lists a number of driver behaviors 1102 that can be captured by a driver-looking camera. The GIA scoring template shown in FIG. 12 lists a number of HOS violations 1202. The evaluator can use the mouse to click a checkbox next to the observed violation(s) listed in one or more of the GIA scoring templates. After scoring the driver's behavior observed in event packet E1, event packet E1 is removed 808 from the queue.

The evaluator selects 812 the next event packet in the queue, such as event packet E2. After reviewing 814 the video clip and other related data associated with event packet E2, the evaluator scores 816 the driver's behavior observed in the video clip of event packet E2. Event packet E2 is then removed from the queue. The processes of selecting 822, reviewing 824, and scoring 826 are repeated for the next selected event packet En, followed by removal 828 of event packet En from the queue. Having processed all received event packets in the queue, the evaluator awaits 830 arrival of additional event packets for subsequent evaluation.

FIGS. 9-12 show representative GIA scoring templates that can be used to manually or algorithmically score driver behavior. Each of the GIA scoring templates shown in FIGS. 9-12 lists a number of different driver behaviors, and includes a checkbox and a severity rating associated with each driver behavior. The severity ratings of the GIA scoring templates illustrated in FIGS. 9-12 are equivalent to the severity weights specified in the SMS/CSA scoring system. It is understood that FIGS. 9-12 list a subset of the more important violations that can be scored in accordance with the SMS/CSA scoring system. It is further understood that SMS/CSA violations can be added (or deleted) from those listed in FIGS. 9-12. A complete listing of SMS/CSA violations can be found in the Comprehensive Safety Analysis (CSA) Safety Measurement System (SMS) Methodology Version 3.0.2, Revised June 2014.

FIG. 9 shows a GIA scoring template that lists a number of event-based driver behaviors 902. Associated with each driver behavior 902 is a checkbox 904 and a severity rating 906. Each of the behaviors 902 listed in FIG. 9 corresponds to an event that can be detected by the onboard computer or mobile gateway of a vehicle. As such, a human evaluator is not needed to score the behaviors 902 listed in FIG. 9. Rather, a processor of the central office, fleet management system or evaluation station can determine which behaviors 902 are present in the event data and algorithmically assign the corresponding severity rating to the driver's behavior scoring profile. The processor can also activate the checkbox 904 (e.g., insert an X) to indicate which behaviors 902 have been detected in the event data by the processor. In the representative embodiments shown in FIG. 9, the processor determines that a “Sudden Stop” violation 902 is indicated by the event data, inserts an X in the associated checkbox 904, and assigns the corresponding severity rating 906 (i.e. 3) to the driver's behavior scoring profile.

Similarly, the HOS violations 1202 listed in FIG. 12 can be evaluated algorithmically, since HOS violations 1202 are detected by the onboard computer or mobile gateway and indicated in the event data received from the driver's vehicle. For each HOS violation 1202 that is algorithmically detected (e.g., 34-hour restart violation), the appropriate checkbox 1204 can be activated (e.g., indicated by an X) and the appropriate severity rating 1206 (e.g., 7) assigned to the driver's behavior scoring profile.

Detecting the driver behaviors 1002 and 1102 listed in FIGS. 10 and 11 involve human evaluation of video clips received from the onboard computer or mobile gateway of commercial vehicles. The driver behaviors 1002 listed in FIG. 10 are those that can be detected based on a video clip produced from a forward-looking camera mounted at the vehicle. In the representative example shown in FIG. 10, the evaluator determines that the driver is following too closely to the vehicle immediately ahead, and that an improper turn was made by the driver. In response to these observations, the evaluator activates the checkboxes 1004 associated with each of these violations 1002. The processor of the evaluation station assigns the appropriate severity ratings (e.g., 5) for each of these violations to the driver's behavior scoring profile. It is noted that the “following too close” and “improper lane change” behaviors listed in FIG. 10 can, in some embodiments, be detected by sensors provided at the vehicle, such as by use of a lane departure sensor or a following distance sensor described hereinbelow. In such embodiments, these sensed behaviors can be scored algorithmically rather than manually.

The driver behaviors 1102 listed in FIG. 11 can be detected based on a video clip produced from a driver-looking camera mounted at the vehicle. In the representative example shown in FIG. 11, the evaluator determines that the driver is engaging in driving while texting and that the driver was subject to other distractions. In response to these observations, the evaluator activates the checkboxes 1104 associated with each of these violations 1102. The processor of the evaluation station assigns the appropriate severity ratings (e.g., 10 and 5, respectively) for each of these violations to the driver's behavior scoring profile.

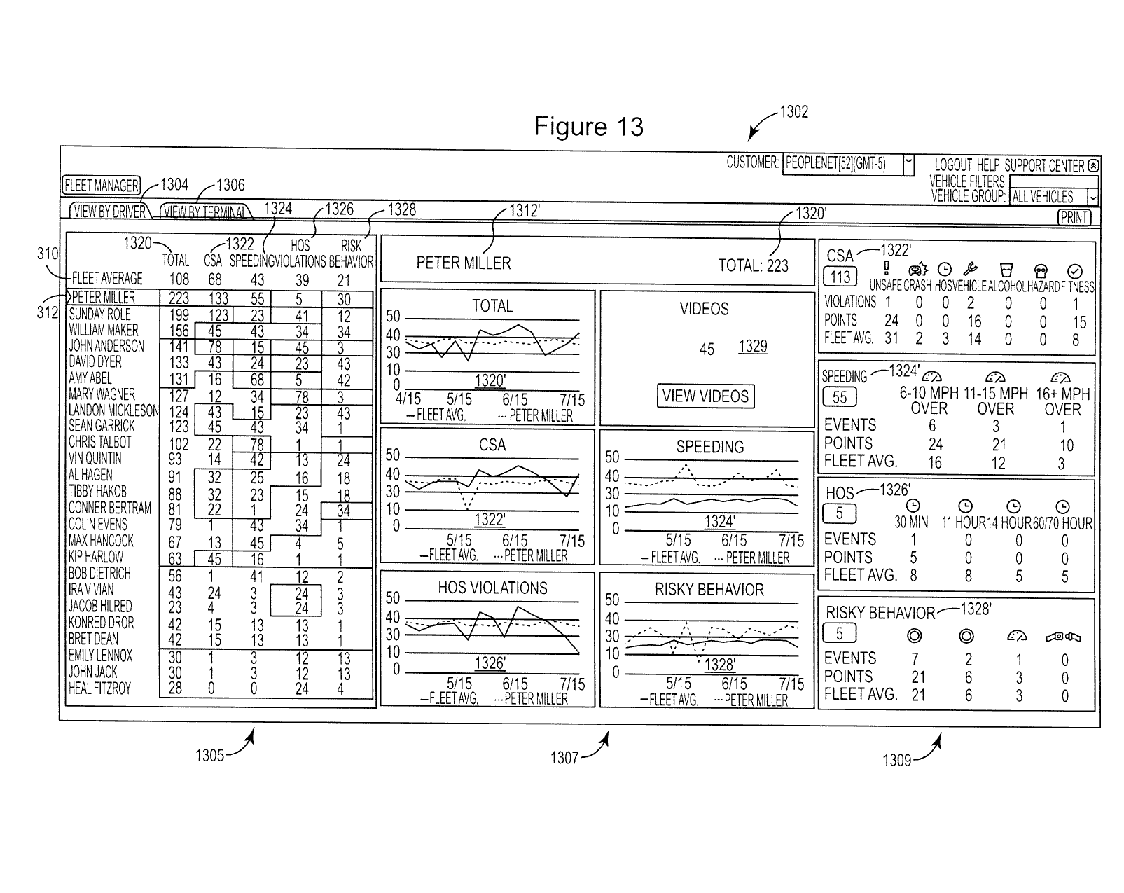

FIG. 13 is a representative screen or report generated by a processor using data stored in a driver behavior scoring database in accordance with various embodiments. The screen or report 1302 shown in FIG. 13 includes three main panels of information. The first panel 1305 provides fleet-wide scoring information for a multiplicity of drivers for a given fleet. The second panel 1307 includes detailed information concerning a particular driver selected from the drivers presented in panel 1305. The third panel 1309 includes detailed information concerning various violations assigned to the selected driver. The screen or report 1302 shown in FIG. 13 can be displayed on a review portal coupled to a fleet management system, a mobile device (e.g., a laptop, tablet or smartphone), or an evaluation station display, or printed as a hardcopy report, for example.

In the embodiment shown in FIG. 13, the first panel of information 1305 can be displayed in terms of individual drivers or in terms of terminals. Viewing the information by driver is selected using tab 1304, while viewing the data by terminal is selected using tab 1306. The information shown in panel 1305 is based on individual drivers. The first column in information panel 1305 lists all (or a subset) of drivers 1312 of a particular fleet. Information on the fleet average 1310 is presented at the top of the first column. For each driver 1312 and the fleet average 1310, five columns of scores are provided. The five columns of scores include a total score 1320, which is a summing of a CSA score 1322, a speeding score 1324, a HOS violations score 1326, and a driver behavior score 1328. The data shown in information panel 1305 is sorted by total score 1320, such that drivers with the highest total score 1320 are displayed at the top of the panel 1305. The user can click on any of the five columns to sort the data according to the selected column.

The scoring information presented by individual driver for a particular fleet shown in information panel 1305 provides an efficient means for identifying problem drivers. In addition to providing numeric scores, a coloring scheme can be superimposed to distinguish between positive, questionable/suspect, and negative scores. For example, the color red can be used to highlight scores that exceed predetermined thresholds that indicate negative driver behavior. The color yellow can be used to highlight scores that indicate questionable or suspect driver behavior. The color green can be used to highlight scores that indicate positive or acceptable driver behavior.

A user can view detailed information concerning a particular driver 1312 by clicking on the driver of interest in the first information panel 1305. Clicking on the selected driver (e.g., Peter Miller) populates the second and third panels 1307 and 1309 with detailed information concerning the selected driver. The second panel 1307 identifies the selected driver 1312′ as well as the selected driver's total score 1320′. In the representative embodiment shown in FIG. 13, the second panel 1307 is populated with graphs for each of the scoring columns presented in the first information panel 1305. Graph 1320′, for example, provides driver and fleet curves based on the total scores 1320 over a span of time, which can be months or years. Graph 1322′ provides driver and fleet curves based on CSA scores 1322 over a specified span of time. Graph 1324′ provides driver and fleet curves based on speeding scores 1324 over a specified span of time. Graph 1326′ provides driver and fleet curves based on HOS violation scores 1326 over a specified span of time. Graph 1328′ provides driver and fleet curves based on driver behavior scores 1328 over a specified span of time. The second information panel 1307 further includes a video panel 1329 which indicates the number of videos that are associated with the selected driver 1312′ for viewing. Clicking on the video panel 1329, for example, can open a window containing each of the available videos, such as the window shown in FIG. 4A.

The third information panel 1309 provides detailed information for each of the score columns 1322, 1324, 1326, and 1328 shown in the first information panel 1305. The columns of CSA data provided in the CSA violation section 1322′ are labeled “unsafe,” “crash,” “HOS,” “vehicle,” “alcohol,” “hazard,” and “fitness.” For each of these columns, the number of violations, driver points (severity rating or points), and fleet average points are tabulated. The columns of speeding data provided in the speeding violation section 1324′ are labeled “6-10 mph over,” “11-15 mph over,” and “15+ mph over.” For each of these columns, the number of events, driver points, and fleet average points are tabulated. The columns of HOS data provided in the HOS violation section 1326′ are labeled “30 Min,” “11 Hour,” “14 Hour,” and “60/70 Hour.” For each of these columns, the number of events, driver points, and fleet average points are tabulated. The columns of driver behavior data provided in the driver behavior section 1328′ are identified by a red light, a green light, a speedometer, and an unbuckled seat belt icon. For each of these columns, the number of events, driver points and fleet average points are tabulated. The red light data corresponds to driver data that is considered negative or unacceptable. The green light data corresponds to driver data that is considered positive or acceptable. The speedometer data refers to speeding data, and the unbuckled seat belt data refers to incidences of seatbelts being unbuckled during vehicle operation.

It will be appreciated that the type of data and the manner of presenting this data as shown in the representative embodiment of FIG. 13 are for illustrative, non-limiting purposes, and that other information and ways of presenting such information are contemplated.

A conventional approach to conducting a review of a driving event with the driver of a commercial vehicle typically involves waiting for the driver to return to a fleet office to meet with a safety manager. Because a commercial driver may be on the road for extended periods of time, a meeting between the driver and the safety manager may take place several days after the occurrence of a particular driving event. Due to the passage of time, interest in, and recollection of details concerning, the driving event are greatly diminished, thereby significantly reducing the efficacy of the driver review meeting.

Embodiments of the present disclosure provide for timely review of event-related information by the driver of a commercial vehicle soon after an event occurs, typically on the order of hours (e.g., 1-2 hours). In particular, embodiments of the present disclosure provide for timely assembly and transmission of an event packet by a processor at the central office (e.g., a fleet management server) soon after an event occurs for purposes of facilitating a review process by a driver of a commercial vehicle. In some embodiments, the event packet includes event data associated with a recent event that occurred during vehicle operation. In other embodiments, the event packet includes a video clip and event data associated with a recent event that occurred during vehicle operation. According to various embodiments, the event packet can further include scoring data for the event. It is understood that the term “in-cab” in the context of event packet review is intended to refer to review of event packets in or around the vehicle, such as at a truck stop, restaurant, or motel.

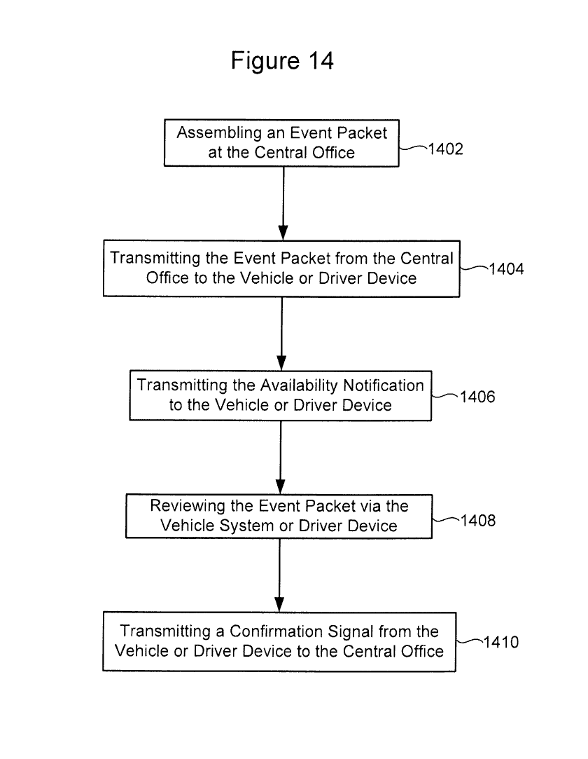

FIG. 14 illustrates various processes involving an in-cab review methodology in accordance with various embodiments. The method shown in FIG. 14 involves assembling 1402 an event packet at a central office using one or both of event data and video data received from a commercial vehicle. The event packet assembled by a processor at the central office (e.g., a processor of a fleet management server) includes information about the event derived from the event data and, if available, includes a video clip of the event produced from one or more cameras (and optionally one or more microphones) provided at the vehicle. As was discussed previously, minor events may not result in creation of the video clip in accordance with some embodiments. The method shown in FIG. 14 also involves transmitting 1404 the event packet from the central office (via a communication device) to a device accessible by the driver. In some implementations, the event packet is transmitted to the onboard computer or mobile gateway of the vehicle for presentation on a display within the cab. In other implementations, the event packet is transmitted to a communication device carried by the driver, such as a tablet, laptop, or smart phone (e.g. Android or iOS device). In further implementations, the event packet is transmitted to both the in-cab system and the communication device carried by the driver.

The method further involves transmitting 1406 (via a communication device) an availability notification to one or both of the in-cab device or the driver communication device. The availability notification preferably results in illumination of an indicator on the in-cab device or the driver communication device. The indicator may be an icon or message that indicates to the driver that an event packet is presently available for review. At the next stop or opportunity during non-operation of the vehicle, the driver can review 1408 the event packet in the vehicle or at a truck stop, for example. The driver can review the event data and, if available, a video clip of the event. After completing the review, a confirmation signal is transmitted 1410 from the in-cab system/driver communication device to the central office. The confirmation signal indicates that the driver has completed his or her review of the event packet. The processes illustrated in FIG. 14 can be implemented and completed within a relatively short time after an event has occurred, typically on the order of about 1 to 4 hours (allowing for time to arrive at a truck stop).

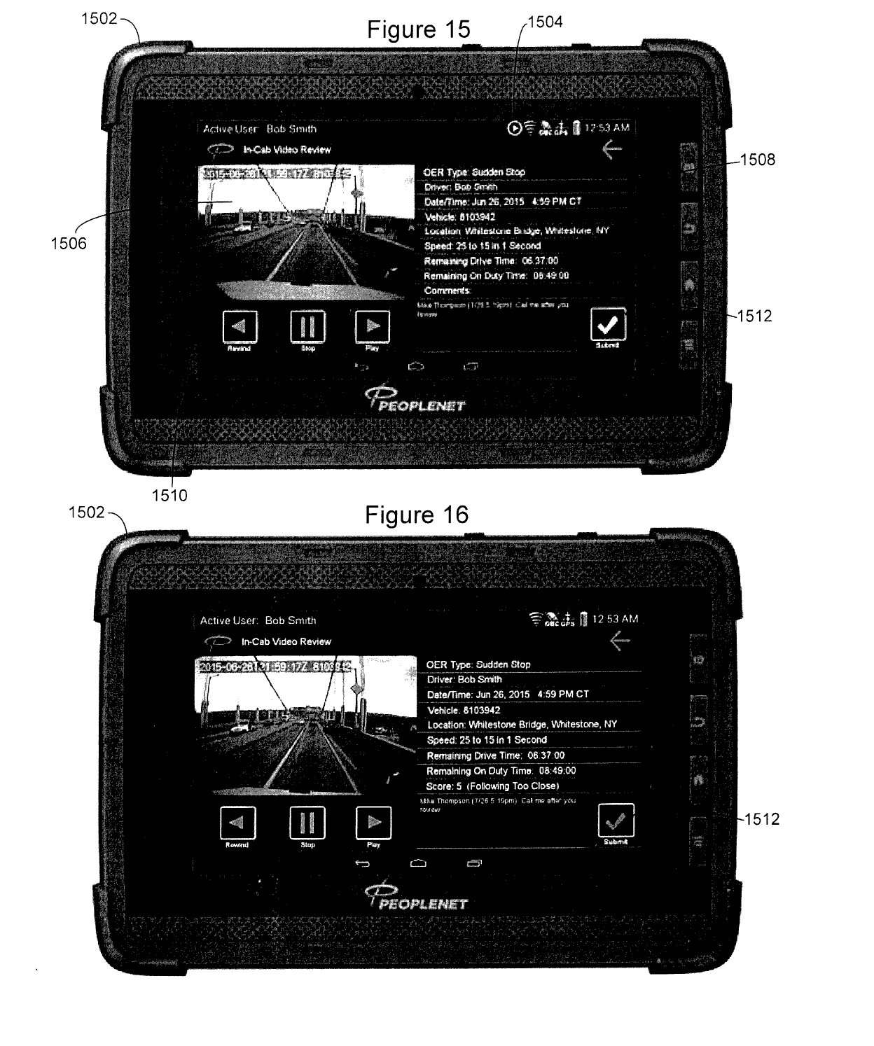

FIGS. 15 and 16 show an in-cab device 1502 that can be used by a driver to conduct an in-cab review of an event packet received from the central office in accordance with various embodiments. The in-cab device 1502 shown in FIG. 15 can be a display of an in-cab system that includes an onboard computer or mobile gateway. In some embodiments, the in-cab device 1502 is fixedly mounted within the cab of the vehicle. In other embodiments, the in-cab device 1502 is a tablet-like device that can be detachably mounted within the cab of the vehicle, and includes a wireless transceiver for communicating with the onboard computer or mobile gateway. The in-cab device 1502 can be configured to execute an app that facilitates in-cab review of an event packet by the driver while sitting in or nearby the vehicle.

As was discussed previously, an availability notification is transmitted to the in-cab device 1502 to indicate that an event packet is available for review. A review icon 1504 is illuminated on the display of the device 1502 to indicate that the event packet can be played by the driver at the appropriate time, such as at the next stop. In some implementations, the review icon 1504 is illuminated on the display of the device 1502, but the video clip 1506 and event data 1508 is not displayed in order to minimize driver distraction. In other implementations, a thumbnail of the video clip 1506 and a summary of event data 1508 can be presented on the display of the device 1502 along with illumination of the review icon 1504.

At the next stop or during a period of non-operation of the vehicle, the driver can review the event data 1508 and any comments that may have been added by the driver's safety manager. For example, the safety manager may add a request for the driver to call the safety manager after completing the review. The driver can review the video clip 1506 by actuating appropriate buttons 1510 (e.g., play, stop, and rewind buttons). After completing the event review, the driver can actuate a submit button 1512, which results in transmission of a confirmation signal from the device 1502 to the central office. The submit button 1512 can change color or other characteristic after actuation to indicate to the driver that of the event review process has been completed and that the confirmation signal has been dispatched to the central office.

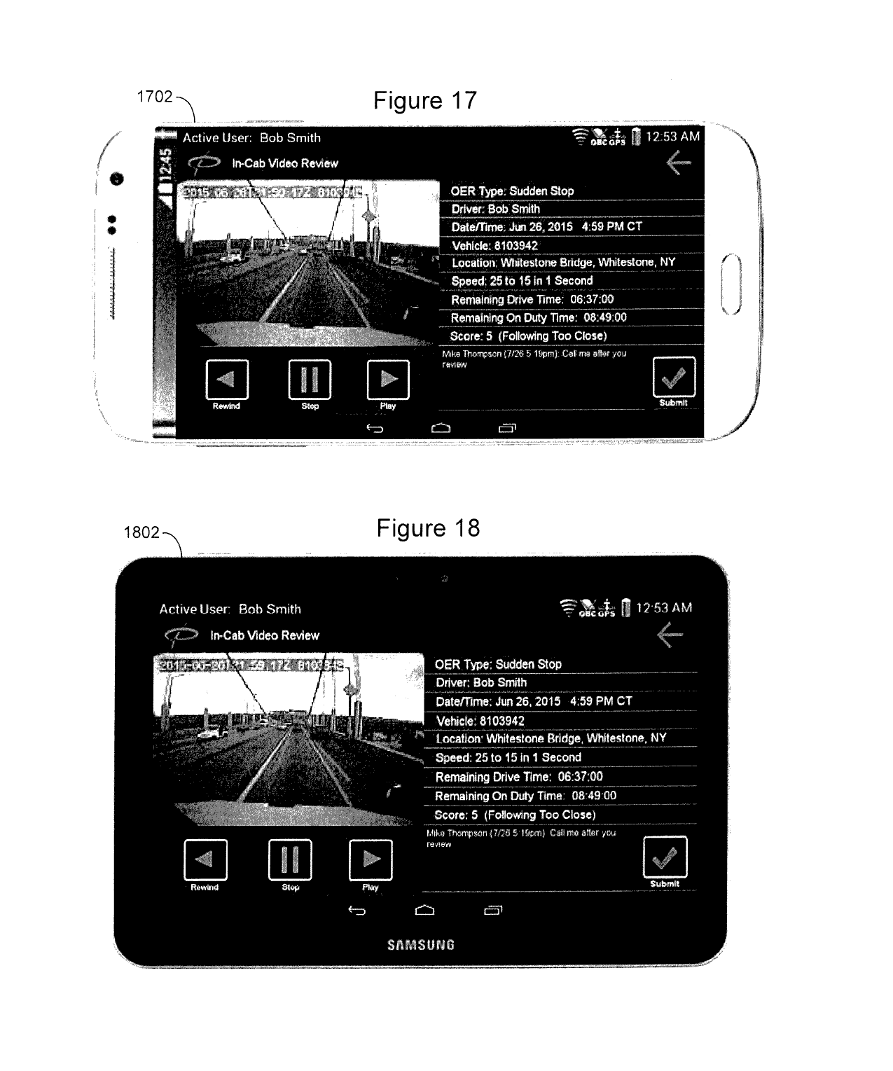

FIGS. 17 and 18 show different driver communication devices that can be used to facilitate review of event packets in accordance with various embodiments. The driver communication device 1702 shown in FIG. 17 is intended to represent an iOS device. The driver communication device 1802 shown in FIG. 18 is intended to represent an Android device. A driver can use either of these devices 1702, 1802 to implement driver review of an event packet using an app or a web application browser. The capabilities and functionality described previously with respect to FIGS. 15 and 16 apply equally to the embodiments shown in FIGS. 17 and 18.

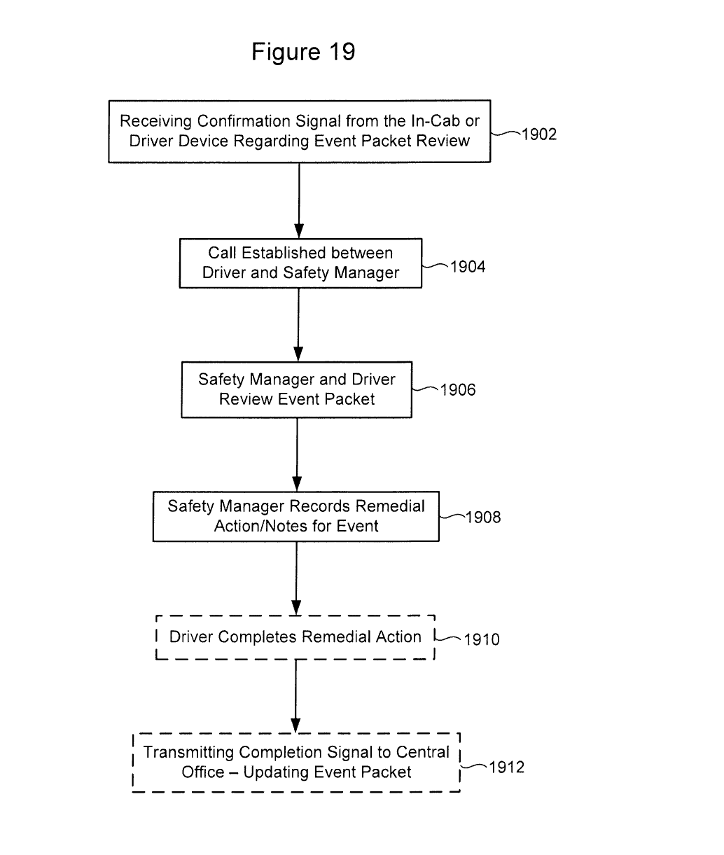

FIG. 19 illustrates various processes involving coaching of a driver using event packet review in accordance with various embodiments. The method illustrated in FIG. 19 involves receiving 1902 at a central office (e.g., by a server of a fleet management system) a confirmation signal from the in-cab or driver device indicating completion of event packet review. In response to the confirmation signal received at the central office, a notification can be dispatched to the driver's safety manager indicating that the driver has completed the event packet review and is available for a coaching session. The coaching session is initiated by establishing a telephone call 1904 or other mode of communication (e.g., texting, skyping) between the safety manager and the driver. The safety manager and the driver can each review the event packet 1906 on their respective devices and can discuss various aspects of the event. The safety manager can record 1908 remedial action, notes and/or instructions for the event which are stored along with the event packet information at the central office (e.g., such as in a fleet management server). For example, the driver may be given the remedial action 1910 to review the video clip of the event several times (e.g., three times). Upon completion of the remedial action, the driver can transmit a completion signal to the central office, which can be reflected in the event packet 1912.

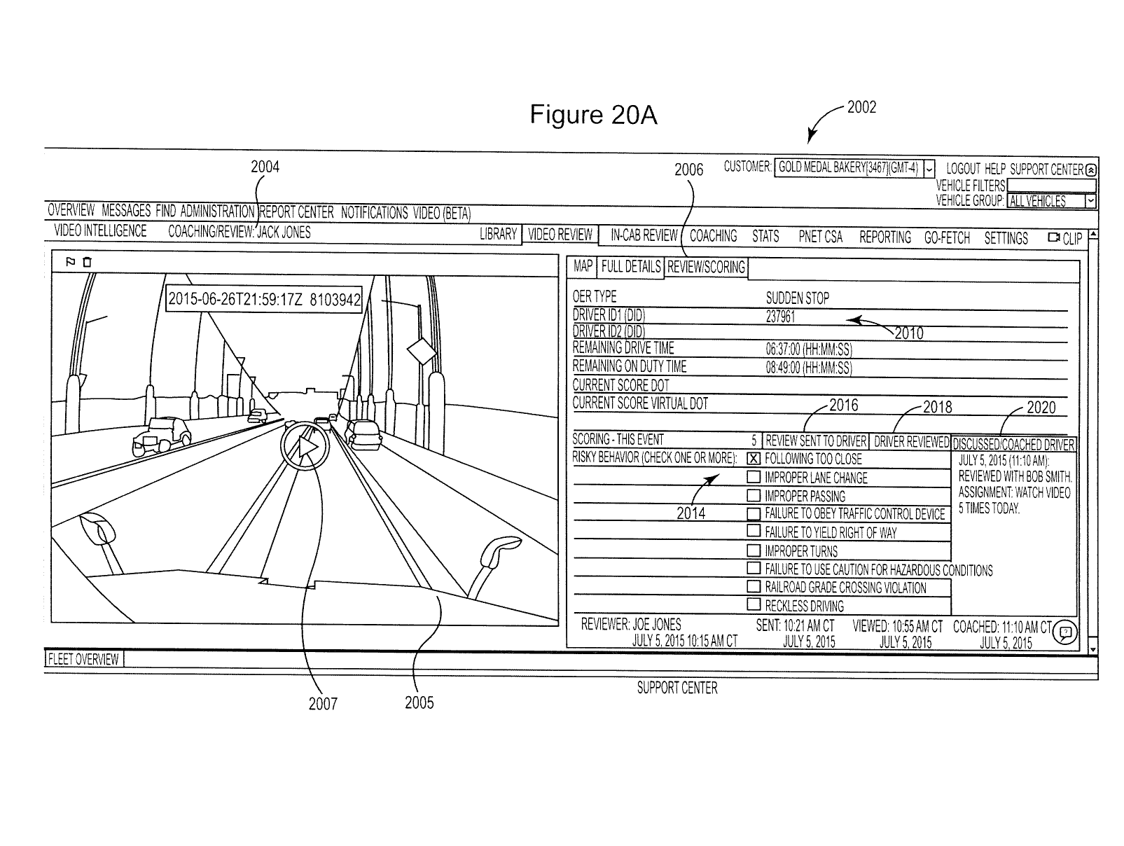

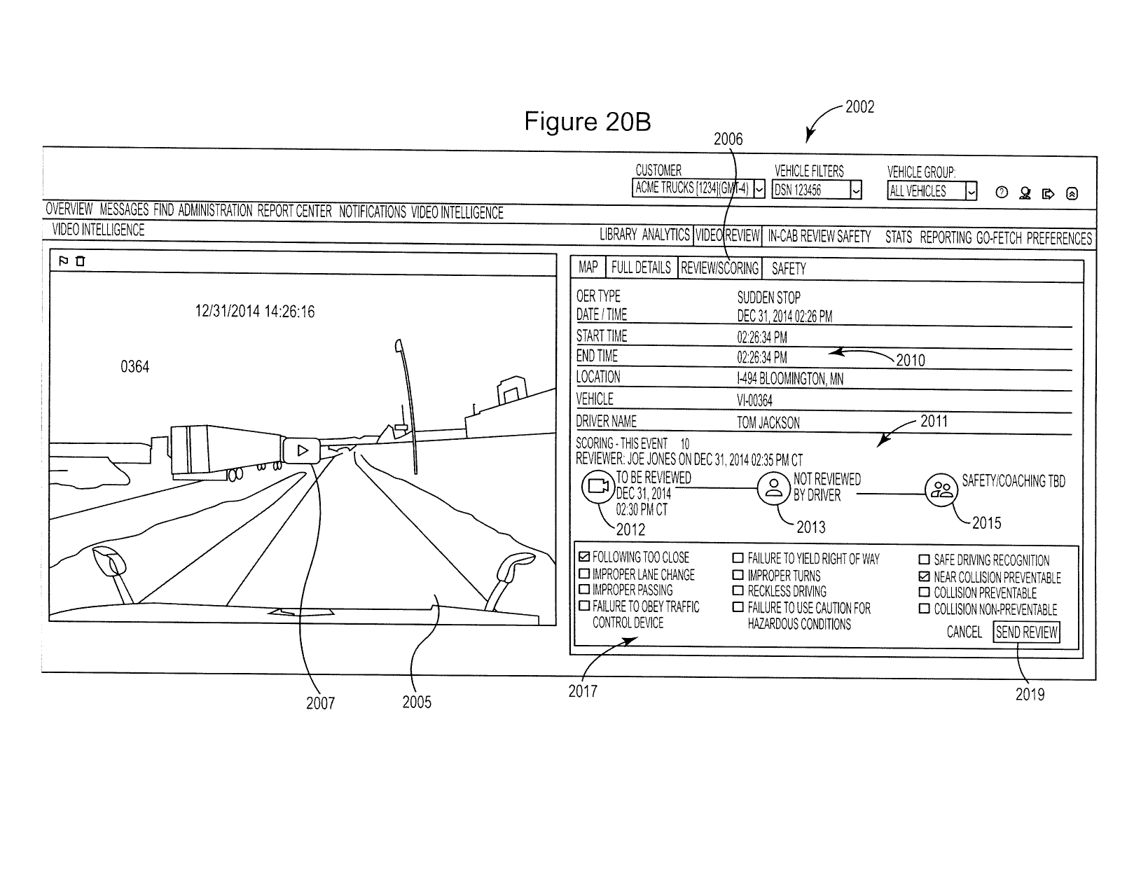

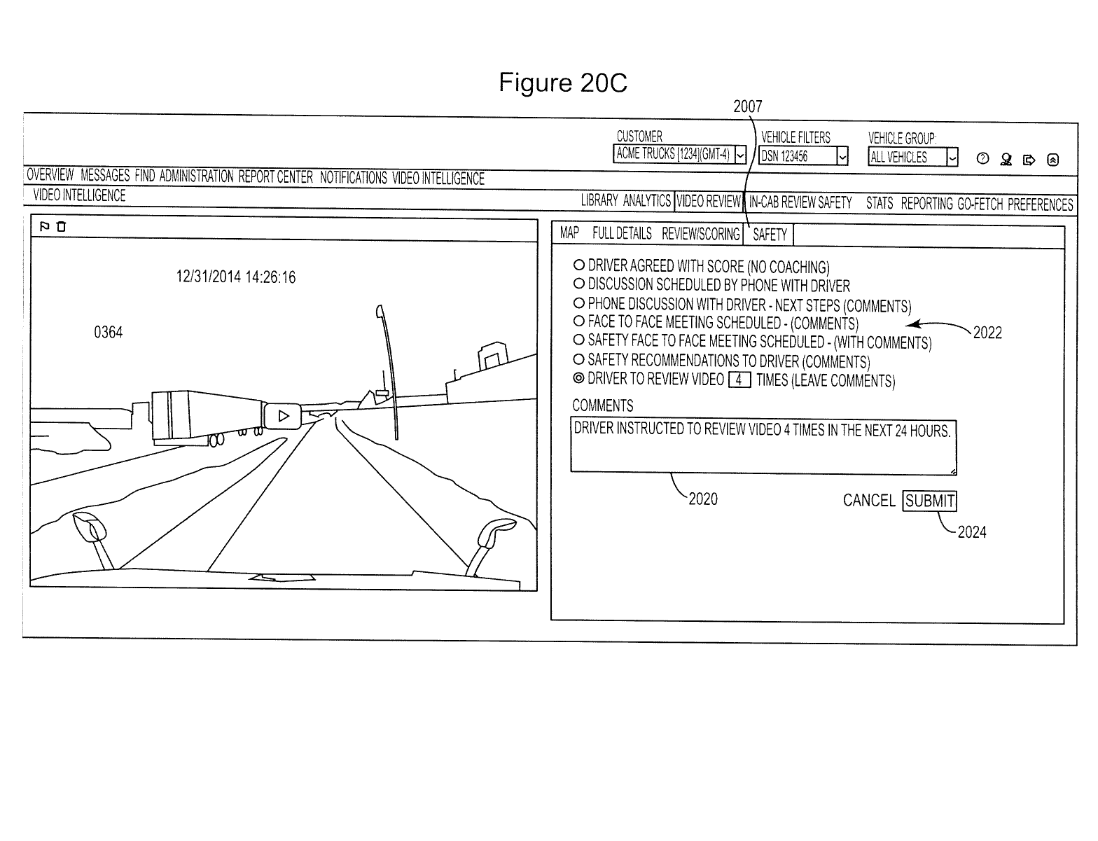

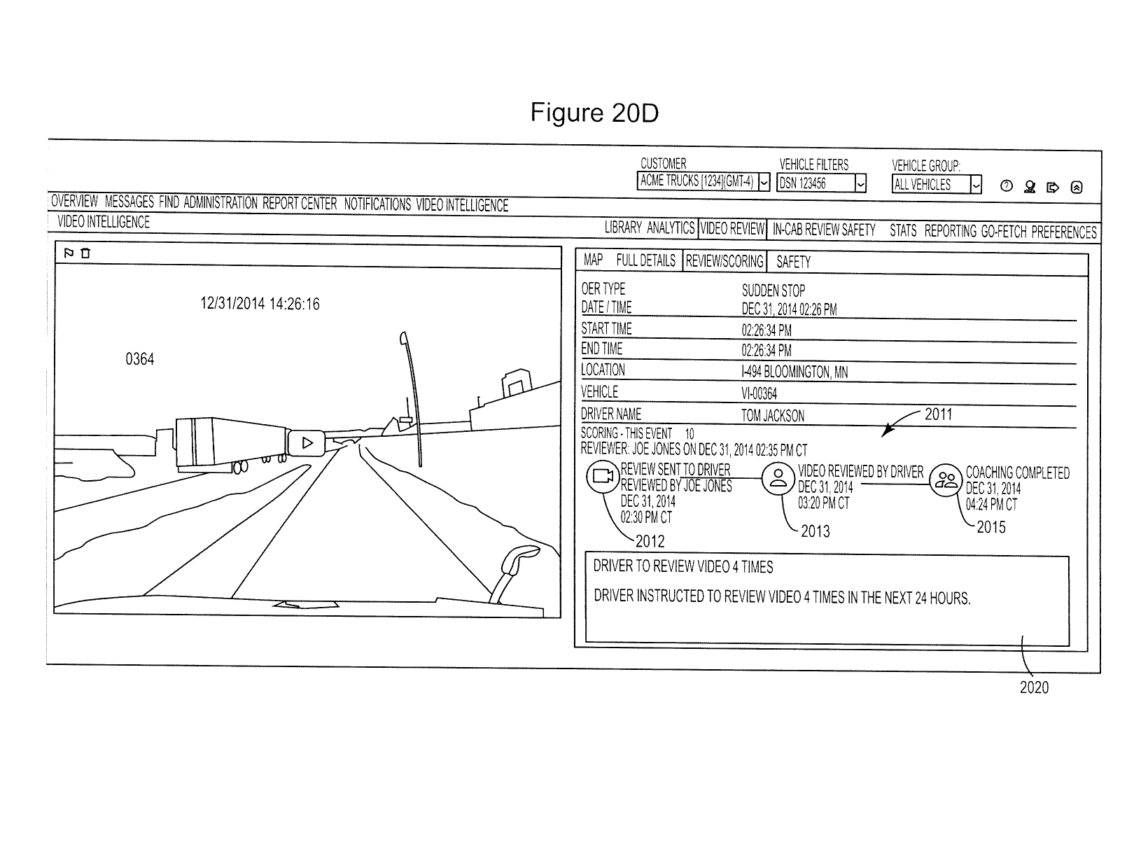

FIG. 20A illustrates an event review screen that can be made available to the safety manager and the driver on their respective devices to facilitate a coaching session in accordance with various embodiments. The event review screen 2002 shown in FIG. 20A can also be accessed by fleet supervisors and other managers (e.g., a driver behavior evaluator or scorer) via a review portal of a fleet management system (e.g., separate from a coaching session). The event review screen 2002 indicates the name of the safety manager 2004 (e.g. Jack Jones) who is conducting the coaching/review session and the date and time of the coaching session. A video clip 2005 of the event can be viewed by actuating the play button 2007. Various event data 2010 is also provided on the screen 2002. The event data 2010 includes the event type (e.g., Sudden Stop), HOS data, driver ID and other related information.

In FIG. 20A, a review scoring tab 2006 has been selected, which results in presentation of driver scoring data 2014 for the event. In this illustrative example, the driver's scorecard indicates that a severity score of 5 points has been assessed to the driver for following too closely to the vehicle immediately ahead. The event review screen 2002 also indicates the time and date in which the review packet was sent to the driver 2016, and the time and date when the driver reviewed the event packet 2018. Notes or remedial action recorded by the safety manager are also shown in the coaching section 2020, as well as the date and time in which the coaching occurred.

FIGS. 20B-20D illustrate different states of an event review screen 2002 in accordance with some embodiments. FIG. 20B shows the state of the event review screen 2002 as it would be presented to an evaluator who is reviewing and scoring an event packet received by the central office or fleet management system. FIG. 20C shows the state of the event review screen 2002 as it would be presented to a safety manager or coach who is providing comments, instructions, and/or remedial action to the driver after having reviewed the event packet. FIG. 20D shows the state of the event review screen 2002 as it would be presented to a user after completion of the review, scoring, and coaching phases of event packet processing at the central office.

A review status panel 2011 indicates the state or status of the event review screen 2002 as the event packet is progressively processed at the central office. The review status panel 2011 includes three status icons 2012, 2013, and 2015. Status icon 2012 indicates the status of the video clip review and scoring process. Status icon 2013 indicates the status of the driver's review of the event packet that was transmitted to the driver's device (e.g., in-cab device or mobile communication device). Status icon 2015 indicates the status of a safety manager's/coach's review of the event packet.

In FIG. 20B, the Review/Scoring tab 2006 has been activated by a user who is manually scoring driver behavior based on a manual evaluation of a video clip 2005. The evaluator can play the video clip 2005 via a play button 2007, and can rewind and fast forward through the video clip 2005 using appropriate buttons (not shown). The evaluator can also view event data 2010 (and detailed event data via the Full Details tab), as well as map information that includes GPS breadcrumb data (via the Map tab). In FIG. 20B, the evaluator has observed two driver violations in the video clip 2005 (“following too close” and “near collision preventable”). It is understood that more or fewer violations can be presented to the evaluator (e.g., such as those shown in FIGS. 10 and 11) during the scoring phase. The evaluator clicks the appropriate box in the driver scoring panel 2017 associated with each of the observed violations. The scoring algorithm (via GIA scoring templates) calculates the severity rating or score for the event packet being evaluated based on the evaluator input in the driver scoring panel 2017 (e.g., 10 severity points in this example). After completing the scoring phase, the evaluator actuates a submit button 2019 (e.g., “send review” button), which causes updating of the status icon 2012 to reflect completion of the scoring phase. For example, the status icon 2012 can change color from yellow (needs review) to green (review completed) to indicate completion of the scoring phase, and/or by providing a textual description of same, which can include the date and time of completion.

In FIG. 20C, the Safety tab 2007 has been activated by a user who is coaching or supervising the driver. A coaching panel 2022 is presented to the user who can click on different radio buttons to record comments, instructions, and/or remedial action to be taken by the driver. In the representative example shown in FIG. 20C, the user can click on the following radio buttons: Driver Agreed with Score (No coaching); Discussion Scheduled by Phone with Driver; Phone Discussion with Driver—Next Steps (comments); Face to Face Meeting Scheduled—(comments); Safety Face to Face Meeting with Driver—Next Steps (with comments); Safety Recommendations to Driver (comments); and Driver to Review Video n Time (leave comments). A comments box 2020 allows the user to input specific comments, instructions, or remedial action to the driver.

After completing the coaching phase, the user actuates a submit button 2024, the status of which is updated and reflected in the review status panel 2011 shown in FIGS. 20B and 20D. FIG. 20D shows the review status panel 2011 for an event packet that has been processed through the scoring, driver review, and coaching phases. The status and date/time of completion for each of these phases is reflected in the status icons 2012, 2013, and 2015, respectively. The coaching comments are also reflected in the comments box 2020.

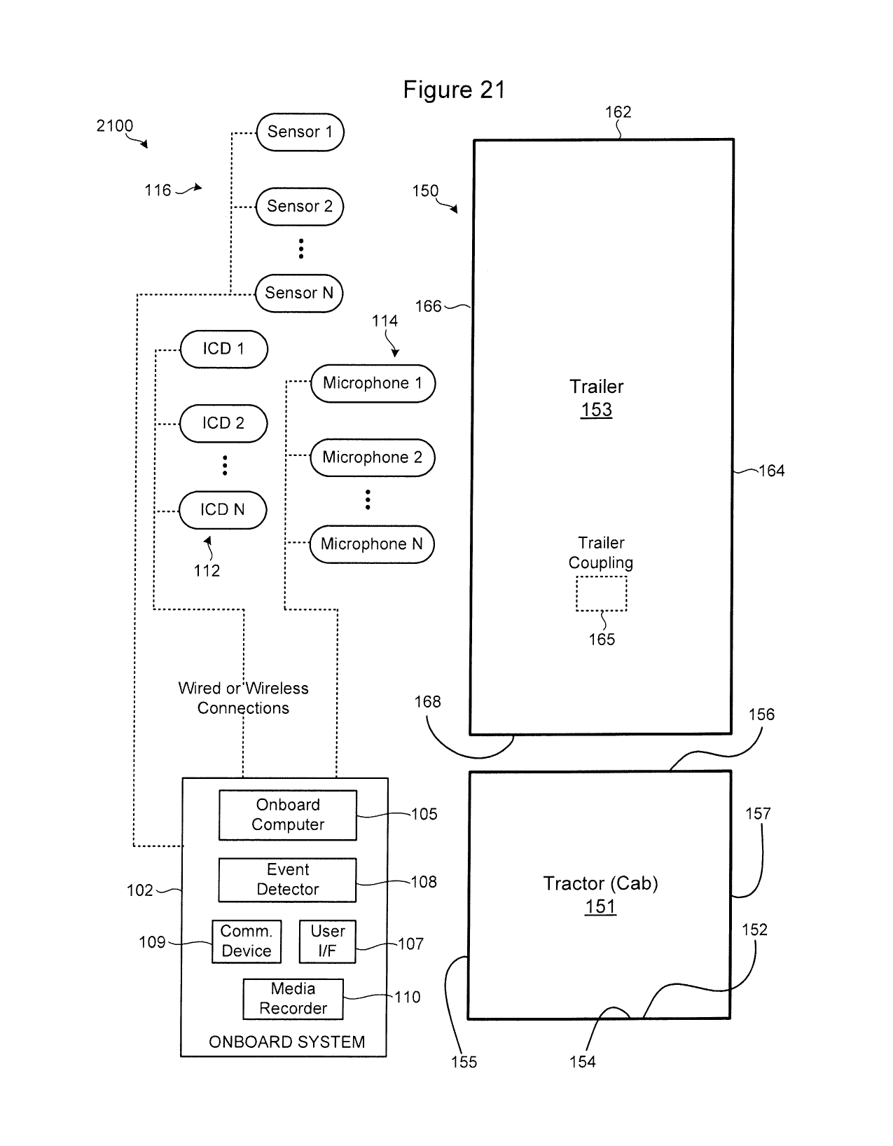

FIG. 21 is a block diagram of an apparatus 2100 for acquiring and processing video, event, and other data for a commercial vehicle 150 in accordance with various embodiments. The apparatus 2100 can be implemented to produce video, audio, event, and sensor data for use by the systems and methods described with reference to FIGS. 1-20.

The apparatus 2100 includes a tractor 151 and a trailer 153 on which various electronic components are respectively mounted. The electronic components include an onboard system 102 which is preferably mounted in the tractor 151 of the vehicle 150. The onboard system 102 is shown to include an onboard computer 105 (which may alternatively be a mobile gateway as described in detail hereinbelow), an event detector 108, a user interface 107, a communication device 108, and a media recorder 110. Each of these components will be described in greater detail hereinbelow. The electronic components further include one or more image capture devices (ICDs) 112 (e.g., video or still photographic cameras), one or more microphones 114, and one or more sensors 116. The image capture devices 112, microphones 114, and sensors 116 are communicatively coupled to the onboard system 102 via wired or wireless connections. It is understood that a given vehicle 150 may be equipped with some, but not necessarily all, of the data acquisition devices shown in FIG. 21 (i.e., image capture devices 112, microphones 114 and sensors 116), and that other data acquisition devices can be mounted to the vehicle 150.

Various embodiments are directed to systems and methods that utilize one or more image capture devices 112 deployed within the tractor 151, and trailer 153, or both the tractor 151 and trailer 153 of the vehicle 150. In addition to the image capture devices 112, the tractor 151 and/or trailer 153 can be equipped to include one or more of the sensors 116 and microphones 114. Various embodiments disclosed herein can include image capture devices 112 situated within the interior or on the exterior of the trailer 153, on the exterior of the tractor 151, and/or within the cab of the tractor 151. For example, the various data acquisition devices illustrated in FIG. 21 can be mounted at different locations in, on, and/or around the trailer 153 and tractor 151 of the vehicle 150. All locations on the interior and exterior surfaces of the trailer 153 and tractor 151 are contemplated.

By way of example, the trailer 153 can include any number of image capture devices 112 positioned in or on the various surfaces of the trailer 153. A single or multiple (e.g., stereoscopic) image capture devices 112 can be positioned on a rear surface 162 of the trailer 153, allowing for driver viewing in a rearward direction of the vehicle 150. One or more image capture devices 112 can be positioned on a left and a right side surface 164 and 166 of the trailer 153, allowing for driver viewing in a rearward and/or lateral direction of the vehicle 150. One or more image capture devices 112 may be positioned on the front surface of the trailer 153, such as at a lower position to facilitate viewing of the hitch area and hose/conduit connections between the trailer 153 and the tractor 151. An image capture device 112 may also be situated at or near the trailer coupling location 165 or at or near other locations along the lower surface of the trailer 153, such as near fuel hoses and other sensitive components of the trailer 153.

In some embodiments, the tractor 151 includes a cab in which one or more image capture devices 112 and optionally microphones 114 and sensors 116 are mounted. For example, one image capture device 112 can be mounted on the dashboard 152 or rearview mirror 154 (or elsewhere) and directed outwardly in a forward-looking direction (e.g., forward-looking camera) to monitor the roadway ahead of the tractor 151. A second image capture device 112 can be mounted on the dashboard 152 or rearview mirror 154 (or elsewhere) and directed toward the driver and passenger within the cab of the tractor 151. In some implementations, the second image capture device 112 can be directed toward the driver (e.g., driver-looking camera), while a third image capture device 112 can be directed toward the passenger portion of the cab of the tractor 151.

The tractor 151 can include one or more exterior image capture devices 112, microphones 114, and/or sensors 116 according to various embodiments, such as an image capture device 112 mounted on a left side 157, a right side 155, and/or a rear side 156 of the tractor 151. The exterior image capture devices 112 can be mounted at the same or different heights relative to the top or bottom of the tractor 151. Moreover, more than one image capture device 112 can be mounted on the left side 157, right side 155 or rear side 156 of the tractor 151. For example, single or multiple (e.g., stereoscopic) left and right side image capture devices 112 can be mounted rearward of the left and/or right doors of the tractor 151 or, alternatively, the near or on the left and/or right side mirror assemblies of the tractor 151. A first rear image capture device 112 can be mounted high on the rear side 156 of the tractor 151, while a lower rear image capture device 112 can be mounted at or near the hitch area of the tractor 151.

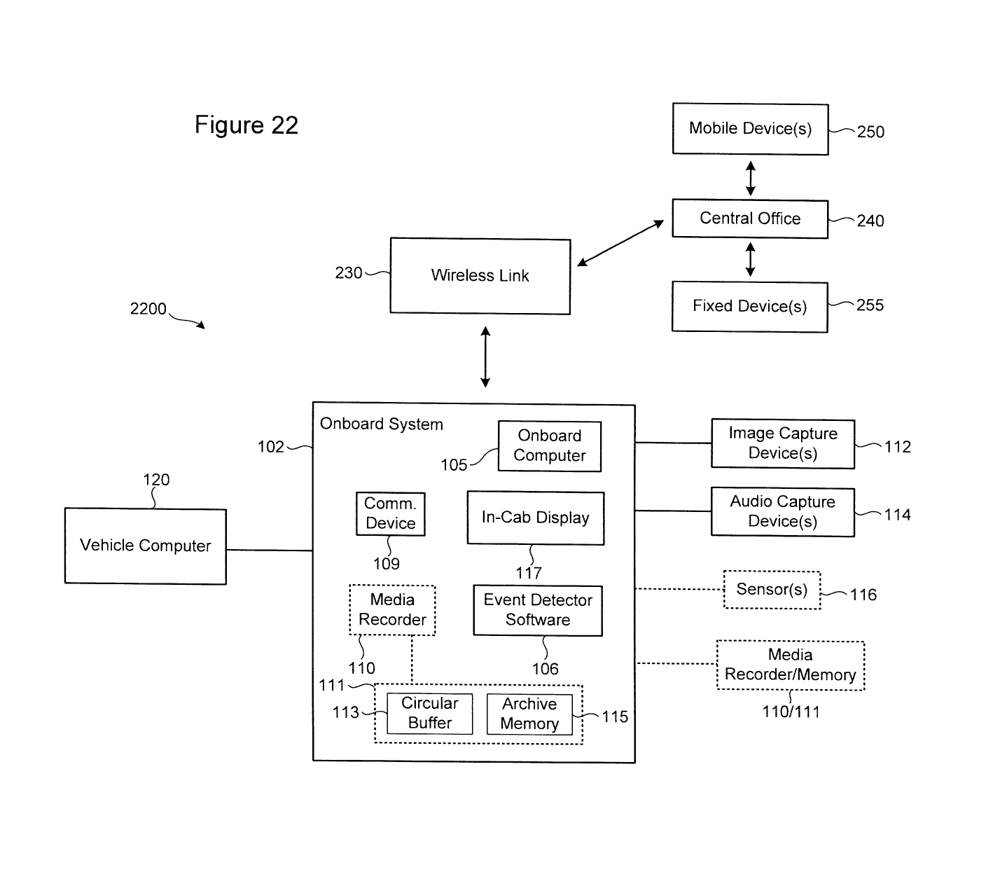

FIG. 22 is a block diagram of a system 2200 for acquiring and processing video, audio, event, sensor, and other data in accordance with various embodiments. The apparatus 2200 can be implemented to produce video, audio, event, and sensor data for use by the systems and methods described with reference to FIGS. 1-20. According to the representative embodiment shown in FIG. 22, the system 2200 includes an onboard system 102 which is provided at the vehicle. Among various components, the onboard system 102 includes an onboard computer 105 (a microprocessor, controller, reduced instruction set computer (RISC), or other central processing module), an in-cab display 117 which can be mounted in the vehicle cab (e.g., fixedly or as a removable handheld device such as a tablet), and Event Detector software 106 stored in a memory of the onboard system 102. The display 117 can be part of a user interface which may include, for example, a keypad, function buttons, joystick, scrolling mechanism (e.g., mouse, trackball), touch pad/screen, or other user entry mechanisms, as well as a speaker, tactile feedback, etc. The memory of the onboard system 102, which may be integral or coupled to a processor of the onboard computer 105, can store firmware, executable software, and algorithms, and may further comprise or be coupled to a subscriber interface module (SIM), wireless interface module (WIM), smart card, or other fixed or removable memory device/media.

The onboard system 102 is communicatively coupled to a vehicle computer 210, which is typically the information hub of the vehicle, and also to a central office 240 (e.g., remote system) via one or more communication links, such as a wireless link 230 via a communication device 108. The communication device 108 can be configured to facilitate over-the-air (OTA) programming and interrogation of the onboard system 102 by the central office 240 via the wireless link 230 and/or other links. Connectivity between the onboard system 102 and the central office 240 may involve a number of different communication links, including cellular, satellite, and land-based communication links. The central office 240 provides for connectivity between mobile devices 250 and/or fixed (e.g., desktop) devices 255 and one or more servers (e.g., fleet management server) of the central office 240. The central office 240 can be an aggregation of communication and data servers, real-time cache servers, historical servers, etc. In one embodiment, the central office 240 includes a computing system that represents at least the communication/data servers and associated computing power needed to collect, aggregate, process and/or present the data, including video and event data, associated with vehicle events. The computing system of the central office 240 may be a single system or a distributed system, and may include media drives, such as hard and solid-state drives, CD-ROM drives, DVD drives, and other media capable of reading and/or storing information.

In some embodiments, the onboard system 102 incorporates a media recorder 110, such as a digital media recorder (DMR), a digital video recorder (DVR) or other media storage device. In other embodiments, the onboard system 102 is communicatively coupled to a separate media recorder 110 via an appropriate communication interface. The media recorder 110 can include one or more memories of the same or different technology. For example, the media recorder 110 can include one or a combination of solid-state (e.g., flash), hard disk drive, optical, and hybrid memory (combination of solid-state and disk memories). Memory of the media recorder 110 can be non-volatile memory (e.g., flash, magnetic, optical, NRAM, MRAM, RRAM or ReRAM, FRAM, EEPROM) or a combination of non-volatile and volatile (e.g., DRAM or SRAM) memory. Because the media recorder 110 is designed for use in a vehicle, the memory of the media recorder 110 is limited. As such, various memory management techniques, such as that described below, can be employed to capture and preserve meaningful event-based data.

The media recorder 110 is configured to receive and store at least image data, and preferably other forms of media including video, still photographic, audio, and data from one or more sensors (e.g., 3-D image data), among other forms of information. Data produced by one or more image capture devices 112 (still or video cameras), one or more audio capture devices 114 (microphones or other acoustic transducers), and one or more sensors 116 (radar, infrared sensor, RF sensor or ultrasound sensor) can be communicated to the onboard system 102 and stored in the media recorder 110 and/or memory 111.

In addition to storing various forms of media data, the media recorder 110 can be configured to cooperate with the onboard computer 105 or a separate processor to process the various forms of data generated in response to a detected event (e.g., sudden deceleration, user-initiated capture command). The various forms of event-related data stored on the media reorder 110 (and/or memory 111) can include video, still photography, audio, sensor data, and various forms of vehicle data acquired from the vehicle computer 120. In some implementations, the onboard computer 105 or other processor cooperates with the media recorder 110 to package disparate forms of event-related for transmission to the central office 240 via the wireless link 230. The disparate forms of data may be packaged using a variety of techniques, including techniques involving one or more of encoding, formatting, compressing, interleaving, and integrating the data in a common or separate file structures. Various embodiments regarding data packaging by the onboard system 102 are described hereinbelow.

It is noted that in some embodiments, the media recorder 110 is equipped (or is coupled to) its own cellular link separate from that used by the onboard system 102 (e.g., separate from the communication device 109). Use of a separate cellular link by the media recorder 110 allows for tailoring the link and the service plan specifically for image/video communication between the vehicle and the central office 240.

According to some embodiments, the memory of the media recorder or other memory 111 (optional) of the onboard system 102 is configured to manage media and other data using a loop memory or circular buffer management approach, whereby data can be acquired in real-time and overwritten with subsequently captured data. In response to a predetermined event, the data associated with the event (data stored prior to, during, and after a detected event) can be transferred from a circular buffer 113 to archive memory 115 within a memory 111 of the onboard system 102. The archive memory 115 is preferably sufficiently large to store data for a large number of events, and is preferably non-volatile, long-term memory. The circular buffer 113 and archive memory 115 can be of the same or different technology. Archived data can be transmitted from the archive memory 115 to the central office 240 using different transfer strategies.

For example, one approach can be based on lowest expected transmission cost, whereby transmission of archived data is delayed until such time as a reduced cost of data transmission can be realized, which can be based on one or more of location, time of day, carrier, required quality of service, and other factors. Another approach can be based on whether real-time (or near real-time) access to the onboard event data has been requested by the driver, the central office 240 or a client of the central office 240, in which case archive memory data is transmitted to the central office 240 as soon as possible, such as by using a data streaming technique. It is understood that the term “real-time” as used herein refers to as near to real-time as is practicable for a given operating scenario, and is interchangeable with the term “substantially in real-time” which explicitly acknowledges some degree of real-world latency in information transmission.

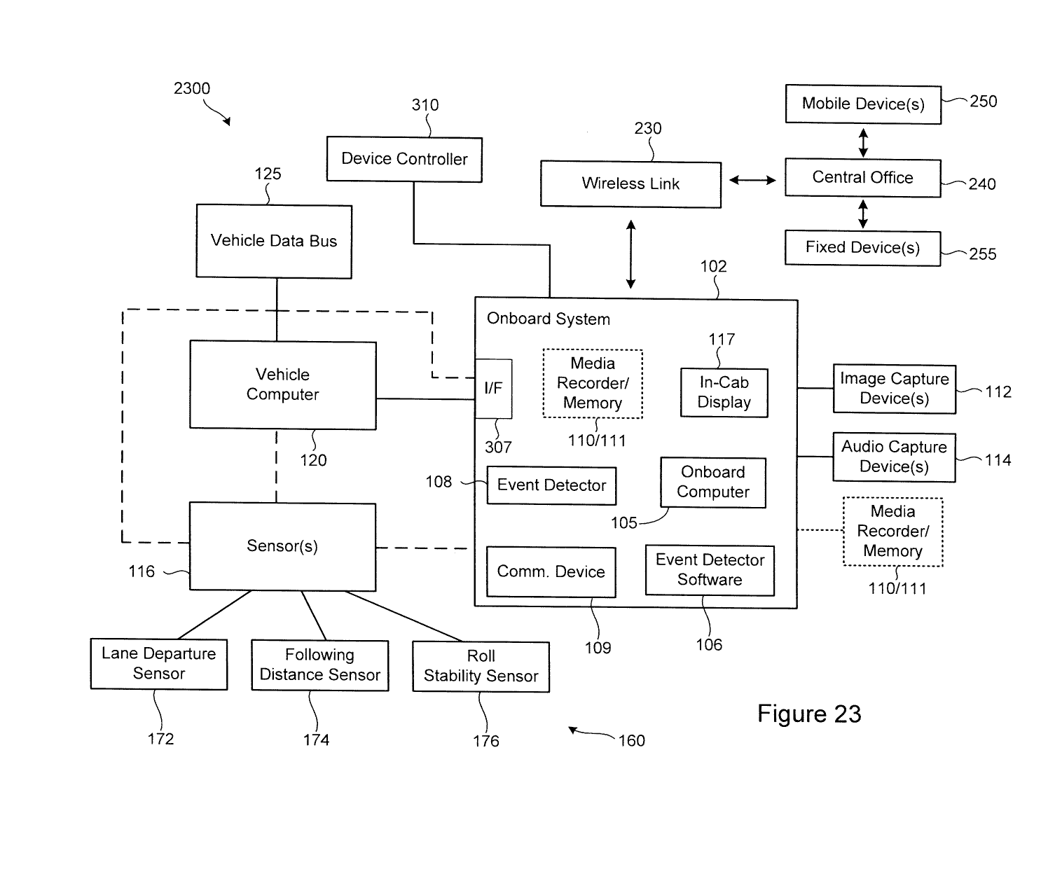

FIG. 23 is a block diagram of a system 2300 for acquiring and processing video, event, sensor and other data in accordance with various embodiments. The apparatus 2300 can be implemented to produce video, audio, event, and sensor data for use by the systems and methods described with reference to FIGS. 1-20. In the representative embodiment shown in FIG. 23, the system 2300 includes an onboard system 102 communicatively coupled to a vehicle computer 120 via an interface 307 and to a central office 240 via a wireless link 230 (and possibly other links). The central office 240 is coupled to the onboard system 102 via a cellular link, satellite link and/or a land-based link, and can be communicatively coupled to various mobile entities 250 and fixed devices 255. The onboard system 102 includes an in-cab display 117, an onboard computer 105, Event Detector software 106, and a communications device 108. The onboard system 102 incorporates a media recorder 110 or, alternatively or in addition, is coupled to a separate media recorder 110 or memory system via an appropriate communication interface. In some embodiments, information acquired by the Event Detector software 106 is obtained from the vehicle computer 120 via the interface 307, while in other embodiments the onboard system 102 is coupled to the vehicle data bus 125 or to both the vehicle computer 120 and data bus 125, from which the needed information is acquired for the Event Detector software 106. In further embodiments, the Event Detector software 106 operates on data received from the central office 240, such as information stored in a transportation management system supported at or coupled to the central office 240.

According to the embodiment shown in FIG. 23, a variety of vehicle sensors 160 (e.g., 3^{rd} party sensors) are coupled to one or both of the onboard system 102 and/or the vehicle computer 120, such as via the vehicle data bus 125. A representative, non-exhaustive listing of useful vehicle sensors 160 include a lane departure sensor 172 (e.g., a lane departure warning and forward collision warning system), a following distance sensor 174 (e.g., a collision avoidance system), and a roll stability sensor 176 (e.g., an electronic stability control system). Representative lane departure warning and forward collision warning systems include Mobileye—5 Series, Takata—SAFETRAK, and Bendix—SAFETYDIRECT. Representative electronic stability control systems include Bendix—(ESP) Electronic Stability Program, and Meritor—(RSC) Roll Stability Control. Representative collision avoidance systems include Bendix—WINGMAN and Merito—ONGUARD. Each of these sensors 172, 174, 176 or sensor systems is respectively coupled to the vehicle computer 120 and/or the vehicle data bus 125. In some embodiments, one or more of the vehicle sensors 160 can be directly coupled to the onboard system 102.

A device controller 310 is shown coupled to the onboard system 102. According to some embodiments, the device controller 310 is configured to facilitate adjustment of one or more parameters of the image capture devices 112, the audio capture devices 114, and/or the sensors 116. In some embodiments, the device controller 310 facilitates user or automated adjustment of one or more parameters of the image capture devices 112, such as field of view, zoom, resolution, operating mode (e.g., normal vs. low-light modes), frame rate, and panning or device orientation, for example. The device controller 310 can receive signals generated at the vehicle (e.g., by a component or a driver of the vehicle), by the central office 240, or a client of the central office (e.g., mobile device 250 or fixed device 255).

According to some embodiments, a mobile gateway unit can be implemented at the onboard system, supplementing or replacing an onboard computer. A mobile gateway unit can be implemented for use by the systems and methods described with reference to FIGS. 1-23. A mobile gateway provides a wireless access point (e.g., Wi-Fi hotspot) and a server that provides sensor, video capture, and other data via a network server. This server runs locally on the vehicle, and may utilize a known data access protocol, such as Hypertext Transport Protocol (HTTP). In this way, a commodity user device such as smartphone or tablet can be used to access the vehicle data and other fleet management-type data. This can reduce costs and leverage the development and improvements in general-purpose consumer and/or commercial mobile devices. For example, features such as voice recognition, biometric authentication, multiple applications and protocol compatibility, are available “out-of-the-box” with modern mobile devices, and these features can be useful for in-cab applications.

The mobile gateway serves generally as a data collection and disbursement device, and may include special- or general-purpose computing hardware, such as a processor, a memory, and input/output (I/O) circuitry. In some embodiments, the event recorder of the onboard system can be wirelessly coupled to the mobile gateway, such as via WiFi® or Bluetooth®. The mobile gateway can also include a sensor interface that may be coupled to external data gathering components such as sensor controller, one or more image capture devices, add-on sensors, microphones, among others. The sensor interface may include data transfer interfaces such as serial port (e.g., RS-232, RS-422, etc.), Ethernet, Universal Serial Bus (USB), FireWire, etc.

The sensor controller coupled to the mobile gateway may be configured to read data from vehicle type busses, such as Controller Area Network (CAN). Generally, CAN is a message-based protocol that couples nodes to a common data bus. The nodes utilize bit-wise arbitration to determine which node has priority to transmit onto the bus. Various embodiments need not be limited to CAN busses; the sensor controller (or other sensor controllers) can be used to read data from other types sensor coupling standards, such as power-line communication, IP networking (e.g., Universal Plug and Play), I²C bus, Serial Peripheral Interface (SPI) bus, vehicle computer interface, etc. The sensor controller may be external to the mobile gateway, or it may be incorporated within the mobile gateway, e.g., integrated with main board and/or as an expansion board/module.

In addition to providing data sources, the mobile gateway can employ a publish/subscribe model, which also allows for flexible and extendable views of the data to vehicle occupants (e.g., such as via a user device). The mobile gateway can include a readily-available proximity radio that may use standards such as Wi-Fi® or Bluetooth®. The proximity radio may provide general-purpose Internet access to the user device, e.g., by routing data packets via the wireless network used to communicate with a cloud gateway. A server component can provide local content (e.g., content produced within the mobile gateway) to the user device over the proximity radio via well-known protocols, such as HTTP, HTTPS, Real-Time Streaming Protocol (RTSP), File Transfer Protocol (FTP), Simple Mail Transfer Protocol (SMTP), etc. A commercially available application such as a browser or media player running on the user device can utilize the services of the server component without any customization of the user device. Embodiments of the present disclosure can be implemented to include a mobile gateway facility and functionality as disclosed in the following commonly owned U.S. Provisional Patent Applications: U.S. Provisional Patent Application Ser. 62/038,611 filed Aug. 18, 2014; U.S. Provisional Patent Application Ser. 62/038,592 filed Aug. 18, 2014; and U.S. Provisional Patent Application Ser. No. 62/038,615 filed Aug. 18, 2014, each of which is incorporated herein by reference in its respective entirety.

Systems, devices, or methods disclosed herein may include one or more of the features, structures, methods, or combinations thereof described herein. For example, a device or method may be implemented to include one or more of the features and/or processes described herein. It is intended that such device or method need not include all of the features and/or processes described herein, but may be implemented to include selected features and/or processes that provide useful structures and/or functionality. The systems described herein may be implemented in any combination of hardware, software, and firmware. Communication between various components of the systems can be accomplished over wireless or wired communication channels.

Hardware, firmware, software or a combination thereof may be used to perform the functions and operations described herein. Using the foregoing specification, some embodiments of the disclosure may be implemented as a machine, process, or article of manufacture by using standard programming and/or engineering techniques to produce programming software, firmware, hardware or any combination thereof. Any resulting program(s), having computer-readable program code, may be embodied within one or more computer-usable media such as memory devices or transmitting devices, thereby making a computer program product, computer-readable medium, or other article of manufacture according to the invention. As such, the terms “computer-readable medium,” “computer program product,” or other analogous language are intended to encompass a computer program existing permanently, temporarily, or transitorily on any computer-usable medium such as on any memory device or in any transmitting device. From the description provided herein, those skilled in the art are readily able to combine software created as described with appropriate general purpose or special purpose computer hardware to create a computing system and/or computing subcomponents embodying various implementations of the disclosure, and to create a computing system(s) and/or computing subcomponents for carrying out the method embodiments of the disclosure.

It is to be understood that even though numerous characteristics of various embodiments have been set forth in the foregoing description, together with details of the structure and function of various embodiments, this detailed description is illustrative only, and changes may be made in detail, especially in matters of structure and arrangements of parts illustrated by the various embodiments to the full extent indicated by the broad general meaning of the terms in which the appended claims are expressed.

1. A method, comprising:
detecting, by an onboard computer coupled to one or more sensors and at least one camera, a predetermined vehicle event at each of a plurality of commercial vehicles each operated by a driver;
capturing, by the onboard computer of each vehicle, vehicle event data and a video clip in response to the predetermined vehicle event;
transmitting, by each of the vehicles, the vehicle event data and the video clip;
receiving, at a central office, the vehicle event data and the video clip from the vehicles;
generating, using a processor at the central office, driver behavior scoring algorithmically based on the received data and on manual evaluation of the video clip, wherein the processor is configured to detect violations in the received data and algorithmically apply severity ratings to score the detected violations, and wherein the severity ratings and the driver behavior scoring are consistent with driver behavior scoring conducted by a governmental inspection authority;
electronically acquiring, at the central office, driver violation data collected and scored by the governmental inspection authority; and
producing, using the processor, an output comprising at least the driver behavior scoring and the driver violation scoring for each of the drivers of the plurality of commercial vehicles.

2. The method of claim 1, further comprising:
generating, at the central office, a speed score algorithmically using the received data, the speed score consistent with speed scoring conducted by the governmental inspection authority;
wherein the output comprises at least the driver behavior scoring, the driver violation scoring, and the speed score for each of the drivers of the plurality of commercial vehicles.

3. The method of claim 1, further comprising:
generating, at the central office, an hours of service (HOS) score algorithmically using the received data, the HOS score consistent with HOS scoring conducted by the governmental inspection authority;
wherein the output comprises at least the driver behavior scoring, the driver violation scoring, and the HOS score for each of the drivers of the plurality of commercial vehicles.

4. The method of claim 1, further comprising:
generating, at the central office, a speed score algorithmically using the received data, the speed score consistent with speed scoring conducted by the governmental inspection authority; and
generating, at the central office, an hours of service (HOS) score algorithmically using the received data, the HOS score consistent with HOS scoring conducted by the governmental inspection authority;
wherein the output comprises at least the driver behavior scoring, the driver violation scoring, the speed score, and the HOS score for each of the drivers of the plurality of commercial vehicles.

5. The method of claim 1, further comprising:
computing average driver behavior scoring across a fleet of the commercial vehicles;
wherein the output comprises at least the driver behavior scoring and the fleet average driver behavior scoring.

6. The method of claim 1, wherein:
generating driver behavior scoring comprises generating a driver behavior score for each of a plurality of driver behavior categories; and
each of the driver behavior categories has a predetermined severity rating consistent with a severity rating established by the governmental inspection authority.

7. The method of claim 1, wherein generating driver behavior scoring comprises:
presenting a plurality of driver behavior categories on a user interface, each of the driver behavior categories having a predetermined severity rating consistent with a severity rating established by the governmental inspection authority;
detecting a user input for one or more of the driver behavior categories indicating presence of driver behavior consistent with the one or more driver behavior categories; and
computing a driver behavior score for each driver behavior category based on the user input and the predetermined severity rating.

8. The method of claim 7, further comprising computing a total driver behavior score as a sum of the driver behavior scoring for the driver behavior categories.

9. The method of claim 7, further comprising:
algorithmically adjusting the driver behavior scoring based on the age of a violation for which the driver behavior scoring is computed.

10. The method of claim 1, wherein generating driver behavior scoring comprises:
presenting a plurality of driver behavior categories on a user interface, each of the driver behavior categories having a predetermined severity rating consistent with a severity rating established by the governmental inspection authority;
detecting a user input for one or more of the driver behavior categories indicating presence of driver behavior in the video clip consistent with the one or more driver behavior categories; and
computing a driver behavior score for each driver behavior category based on the user input and the predetermined severity rating.

11. A method, comprising:
detecting, by an onboard computer coupled to one or more sensors, a predetermined vehicle event at each of a plurality of commercial vehicles each operated by a driver;
capturing, by the onboard computer of each vehicle, vehicle event data in response to the predetermined vehicle event;
transmitting, by each of the vehicles equipped with a transceiver, the vehicle event data;
receiving, at a central office, the vehicle data from the vehicles;
generating, using a processor at the central office, driver behavior scoring algorithmically based the received data, wherein the processor is configured to detect violations in the received data and algorithmically apply severity ratings to score the detected violations, and wherein the severity ratings and the driver behavior scoring are consistent with driver behavior scoring conducted by a governmental inspection authority;
electronically acquiring, at the central office, driver violation data collected and scored by the governmental inspection authority; and
producing, using the processor, an output comprising at least the driver behavior scoring and the driver violation scoring for each of the drivers of the plurality of commercial vehicles.

12. The method of claim 11, further comprising:
generating, at the central office, a speed score algorithmically using the received data, the speed score consistent with speed scoring conducted by the governmental inspection authority; and
generating, at the central office, an hours of service (HOS) score algorithmically using the received data, the HOS score consistent with HOS scoring conducted by the governmental inspection authority;
wherein the output comprises at least the driver behavior scoring, the driver violation scoring, the speed score, and the HOS score for each of the drivers of the plurality of commercial vehicles.

13. A system for use with a plurality of commercial vehicles each operated by a driver, comprising:
a vehicle system provided at each vehicle, the vehicle system comprising an onboard computer coupled to one or more sensors, at least one camera, and a transceiver, the vehicle system configured to capture vehicle event data and a video clip in response to detecting a predetermined vehicle event and to transmit the vehicle event data and the video clip via the transceiver;
a server configured to receive the vehicle event data and the video clip from the vehicles, the server also configured to receive driver violation data collected and scored by a governmental inspection authority;
one or more scoring templates for associating driver violations with severity ratings consistent with severity ratings established by the governmental inspection authority;
one or more scoring modules configured to algorithmically generate driver behavior scoring using the received data and the one or more scoring templates, wherein the algorithmically generated driver behavior scoring is consistent with driver behavior scoring conducted by the governmental inspection authority;
a manual evaluation station configured to facilitate manually generated driver behavior scoring using the video clip and the one or more scoring templates, wherein the manually generated driver behavior scoring is consistent with driver behavior scoring conducted by the governmental inspection authority; and
a processor configured to produce an output comprising at least the driver behavior scoring and the driver violation scoring for each of the drivers of the plurality of commercial vehicles.

14. The system of claim 13, wherein:
the one or more scoring modules comprises a speed scoring module configured to algorithmically generate a speed score using the received data and a speed scoring template; and
the processor is configured to produce an output comprising at least the driver behavior scoring, the driver violation scoring, and the speed score for each of the drivers of the plurality of commercial vehicles.

15. The system of claim 13, wherein:
the one or more scoring modules comprises an hours of service (HOS) scoring module configured to algorithmically generate an HOS score using the received data and an HOS scoring template; and
the processor is configured to produce an output comprising at least the driver behavior scoring, the driver violation scoring, and the HOS score for each of the drivers of the plurality of commercial vehicles.

16. The system of claim 13, wherein:
the one or more scoring modules comprises a speed scoring module configured to algorithmically generate a speed score using the received data and a speed scoring template;
the one or more scoring modules comprises an hours of service (HOS) scoring module configured to algorithmically generate an HOS score using the received data and an HOS scoring template; and
the processor is configured to produce an output comprising at least the driver behavior scoring, the driver violation scoring, the speed score, and the HOS score for each of the drivers of the plurality of commercial vehicles.

17. The system of claim 13, wherein the processor is configured to:
compute average driver behavior scoring across a fleet of the commercial vehicles; and
produce the output to include the fleet average driver behavior scoring.

18. The system of claim 13, wherein:
the manual evaluation station includes a user interface comprising a display and an input device;
a selected scoring template is configured to be presented on the display and to receive a user input via the input device indicating observance of a driver violation; and
the manual evaluation station is configured to compute a driver behavior score based on the user input and the severity rating associated with the indicated driver violation.

19. A system for use with a plurality of commercial vehicles each operated by a driver, comprising:
a vehicle system provided at each vehicle, the vehicle system comprising an onboard computer coupled to one or more sensors, and a transceiver, the vehicle system configured to capture vehicle event data in response to detecting a predetermined vehicle event and to transmit the vehicle event data via the transceiver;
a server configured to receive the vehicle data from the vehicles, the server also configured to receive driver violation data collected and scored by a governmental inspection authority;
one or more scoring templates for associating driver violations with severity ratings consistent with severity ratings established by the governmental inspection authority;
one or more scoring modules configured to algorithmically generate driver behavior scoring using the received data and the one or more scoring templates, wherein the algorithmically generated driver behavior scoring is consistent with driver behavior scoring conducted by the governmental inspection authority; and
a processor configured to produce an output comprising at least the driver behavior scoring and the driver violation scoring for each of the drivers of the plurality of commercial vehicles.

20. The system of claim 19, wherein:
the one or more scoring modules comprises a speed scoring module configured to algorithmically generate a speed score using the received data and a speed scoring template;
the one or more scoring modules comprises an hours of service (HOS) scoring module configured to algorithmically generate an HOS score using the received data and an HOS scoring template; and
the processor is configured to produce an output comprising at least the driver behavior scoring, the driver violation scoring, the speed score, and the HOS score for each of the drivers of the plurality of commercial vehicles.
